(19) United States
(12) Patent Application Publication
(10) Pub. No.: US 2007/0288355 A1
(43) Pub. Date: Dec. 13, 2007

(54) Evaluating customer risk

(76) Inventors: Bruce Roland, Finksburg, MD (US); Deven C. Swim, Quincy, MA (US); Thomas Messina, Scarsdale, NY (US); Walker P. Conolly, New York, NY (US)

Correspondence Address: FISH & RICHARDSON P.C., P.O. BOX 1022, MINNEAPOLIS, MN, 55440-1022, US

(21) Appl. No.: 11/442,479

(22) Filed: May 26, 2006

(51) Int. Cl. G06Q 40/00

(52) U.S. Cl. 705/38

(57) ABSTRACT

Evaluating risk associated with a financial organization's customer by prompting a user to respond to a set of questions adapted to solicit customer data relevant to evaluating the risk. The questions are part of a first risk model that includes rules for determining an overall risk rating associated with the customer based on user responses to the questions. Risks associated with individual responses from the user are quantified based on the first risk model. A first overall risk rating for the customer is determined based on the quantified risks.

### FIELD OF THE INVENTION

This disclosure relates to anti-money laundering and/or anti-terrorist funding. More particularly, this disclosure relates to evaluating risk associated with a customer's potential for involvement in money-laundering and/or terrorist financing.

### BACKGROUND

Generally, money laundering includes moving illegally acquired cash through a financial system so that it appears to have been legally acquired. Terrorist financing includes providing money to terrorists. Banks and other financial institutions have an interest in avoiding transactions with customers that may be involved with either money laundering or terrorist funding activities. The anti-money-laundering (AML) and anti-terrorist-funding (ATF) regulatory landscapes are rapidly evolving.

### SUMMARY

A systematic risk-based approach to anti-money laundering and anti-terrorist financing is disclosed. In one aspect, a user can assess the risk that a new or existing customer might engage in either money laundering or terrorist financing. The user could be, for example, an individual bank employee, a group of individuals within a bank or the entire employee pool in a bank. The techniques also enable the user to monitor changes in that risk as a result of evolutions in the regulatory landscape and conventional wisdom.

Moreover, the techniques also can enable the user to measure the effectiveness other risk assessment approaches that the user might have been implementing. In such cases, the techniques can enable the user to collect and consider various data that is relevant to risk assessment, but that might have been overlooked by the user implementing the other risk assessment approach. The techniques may involve prompting the user to enter more data that is relevant to assessing risk. In that way, the user can remediate an existing customer.

In one aspect, a computer-implemented method is disclosed for evaluating risk associated with a financial organization's customer. The method includes prompting a user to respond to a set of questions adapted to solicit customer data relevant to evaluating the risk. The questions are part of a first risk model that includes rules for determining an overall risk rating associated with the customer based on user responses to the questions. Risks associated with individual responses from the user are quantified based on the first risk model. A first overall risk rating for the customer is determined based on the quantified risks.

In certain implementations, the computer-implemented method includes enabling a user to modify the first risk model to create a second risk model. Some implementations also include revising the quantified risks associated with the individual responses from the user based on the second risk model and determining a second overall risk rating for the customer based on the revised quantified risks.

The techniques disclosed herein enable a user to assess a customer's risk at the inception of a relationship with that customer. The techniques also enable a user to periodically reassess that risk.

Other features and advantages will be apparent from the following detailed description, the accompanying drawings and the claims.

### BRIEF DESCRIPTION OF THE DRAWINGS

FIG. 1 is a block diagram representing a computer-based system.

FIG. 2 is a flow chart for a method of assessing risk.

FIGS. 3-46 are screens from a graphical interface.

FIGS. 47A-47D is a flowchart for a customer validation process.

FIG. 48 is a social network diagram.

### DETAILED DESCRIPTION

A systematic risk-based approach to anti-money laundering and anti-terrorist financing is disclosed. The approach enables a user to assess the risk that a potential new customer might engage in either money laundering or terrorist financing. The approach enables the user to monitor how the customer's risk rating (e.g., high, medium and low) changes over time and allows for frequent review and analysis of the risk posed by the customer.

In general, the risk rating reflects the risks posed by the customer's expected transactions and is based, among other things, on the customer's location, structure and environmental influences. The risk model can be applied to each customer as part of an ongoing due diligence process that is initiated at the time of initiating the relationships (e.g., at account opening or loan approval) and continues throughout the duration of the relationship.

The approach also enables a user to change the risk model when appropriate so that the user will be able to better understand how different regulatory changes will affect its customer base. That ability can be particularly important during periods of regulatory fluidity. As an example, if a compliance leader wants to make Iran a higher risk country, the compliance leader can change the application's (system's) risk model to see how such a change will impact the customer base. If the user's customer base includes a large number of Iranian customers, then the overall risk associated with the customer base might be increased significantly. The method allows the compliance leader to make that determination very easily.

In certain implementations, the user can modify the risk model without being required to directly access and directly modify the associated underlying code. Instead, a user-friendly interface is provided, the use of which requires no special knowledge of computer programming. The interface may be accessed directly through a browser or otherwise through a graphical interface.

Also, the method involves storing various versions of the risk model so that the user can easily examine how the risk model has changed over time. Such functionality helps enable an organization to continuously be informed of the impact that particular regulatory changes have on its customer base and to gain a historical perspective on those changes.

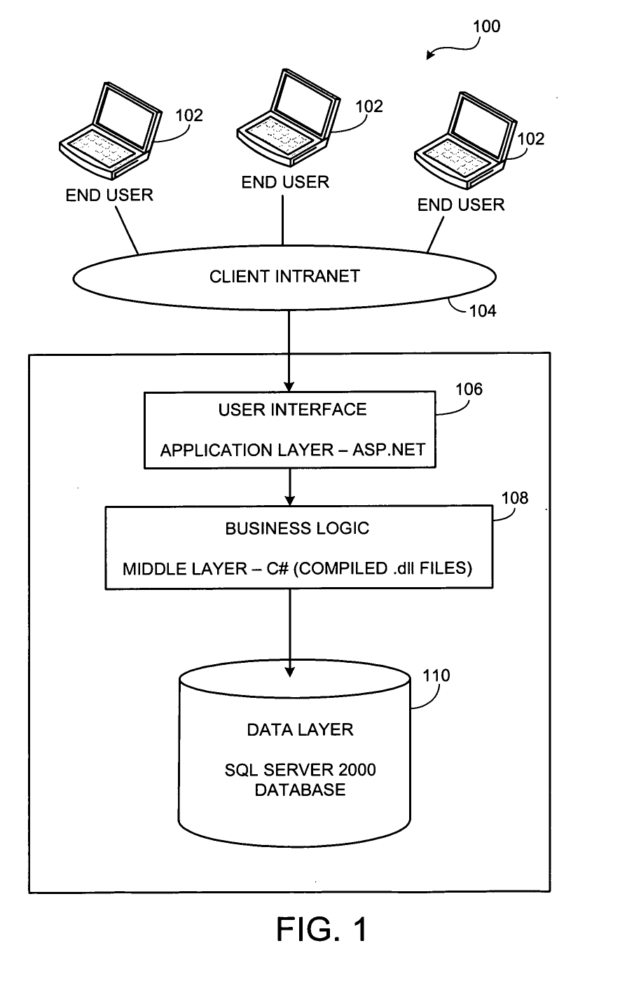

FIG. 1 represents an example of a computer-based system 100 that is adapted to implement the techniques and methods described herein. The system 100 includes user terminals 102 coupled to an intranet 104. Each user terminal 102 includes a processing unit that may assist with, or fully implement, many of the techniques and methods described herein. Each user terminal 102 also includes internal memory which may be used to store data discussed herein and associated with the techniques and methods described herein. Each user terminal includes a graphical display unit that is adapted to present various screens to a user to help that user utilize the techniques and methods described herein. Also, remote processing units and memory storage devices may implement particular aspects of the methods described herein.

The intranet 104 interfaces with an application layer 106, which is adapted to provide user interface services. In the illustrated implementation, the application layer 106 is implemented using asp.net technology. The application layer 106 interfaces with a middle layer 108, which is adapted to implement the business logic associated with the techniques and methods described herein. In the illustrated implementation, the middle layer 108 is implemented using C# compiled .dll files. The middle layer 108 interfaces with a data layer 110, which, in the illustrated implementation, is implemented as an SQL server 2000 database. The data layer 110 is adapted to store various data that is used in the techniques and methods described herein. Such data includes, for example, customer information and risk model parameters.

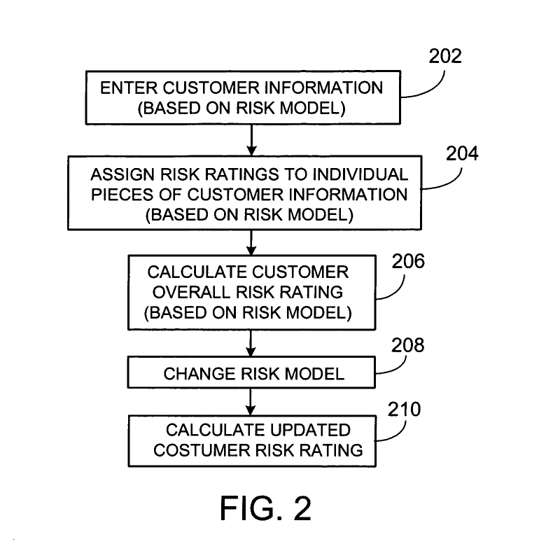

FIG. 2 is a flowchart for a method of assessing the likelihood of risk that a particular customer will engage in money laundering or terrorist financing. The method involves using a risk model to assess that risk. There are various aspects to the risk model and each aspect may be changed over time. Exemplary aspects of the risk model include: 1) an identification of customer information that is relevant to assess the risk associated with that customer; 2) an identification of how the relevant customer information should affect an overall risk rating associated with that customer; and 3) identification of an appropriate method for expressing the level of risk associated with the customer.

The illustrated method includes entering 202 relevant customer information into a database. The relevant customer information to be entered depends on the parameters used by the risk model to assess the risk. The risk model can change over time, for example, in response to the evolution of the regulatory landscape and conventional wisdom. In certain implementations, once the entered information has been validated, a version of that information is saved for historical reference purposes.

After the customer information is entered, a risk rating (e.g., either low, medium or high) is assigned 204 to the relevant pieces of customer information entered. The risk rating assigned to those pieces of information also is a function of the risk model that is to be applied to assess risk.

The system also can be adapted to check whether the customer is on any one of a variety of watch lists that are maintained either internally or externally. Such watch lists might indicate particular customers that the user's organization should avoid entering into a relationship with. An example of such a list is maintained by the Office of Foreign Assets Control (“OFAC”). Other examples include the Bank of England's Sanction List, the Bureau of Industry and Security Denied Person's list, the Federal Bureau of Investigation's most wanted terrorists list, the U.S. Department of State's Terrorist Exclusion List. The system may interface, for example via the internet, with external databases to check those kinds of lists. If the system matches some aspect of the customer's information with information on those lists, the user is informed of that match. The user may then take appropriate actions.

After assigning individual risk ratings to particular pieces of data, an overall risk rating is determined 206 for the customer. The overall risk rating for the customer is determined 206 based on the risk model that is being applied. In certain implementation, that overall risk rating may be saved as part of the customer information as an initial version of the customer information form.

The illustrated method includes changing 208 the risk model. Such a change might be desirable to respond to a change in regulations or conventional wisdom regarding risk assessment. The risk model change may be implemented to reflect, for example, new regulations that may make a particular piece of customer information relevant, new regulations that impact the significance certain customer data may have on risk assessment, or a change in the customer's characteristics (e.g., opening an overseas office) that may impact the risk assessment for that customer. In certain implementations, the new risk model (including any changes thereto) is saved in a database and assigned a new version number.

After changes to the risk model have been entered, the system calculates 210 an updated customer risk rating for affected customers. In one implementation, the system is adapted to report all affected customer risk ratings to the user after each risk model change is entered. The system saves the updated customer risk rating for comparison purposes with previous risk ratings (and later risk ratings) to give a user historical perspective regarding the effect of various regulatory changes.

What follows is a description of a particular implementation of a risk model that can be applied to assess customer risk. Applying this risk model to a particular customer results in a risk rating for the customer that is either low, medium or high. Other rating systems may be implemented that result, for example, in a scaled score, such as a numerical value between 0 and 100.

The risk model segments customers according to various categories. For example, the risk model includes segments for individuals, non-individual entities and financial institutions. An individual is a person who seeks, for example, to open an account for personal use. Examples of non-individual entities include: domestic corporations, foreign corporations, domestic partnerships, foreign partnerships, domestic limited purpose entities, foreign limited purpose entities, non-profit organizations, proprietorships, domestic trusts, religious non-profit organizations, supranational organizations, foreign federal or state governments, domestic federal or state governments and government agencies. Examples of financial institutions include: domestic financial institutions, foreign financial institutions, central banks, money exchanges, insurance companies, domestic broker dealers, foreign broker dealers, domestic brokers, foreign brokers, domestic finance companies, foreign finance companies, domestic asset managers and foreign asset managers.

Such segmentation allows a user more easily to gather appropriate data needed to conduct proper due diligence for each of the three customer types at the time of new customer registration and account opening. Also, such segmentation allows a user more accurately to assign risk ratings to its customers. The actual risk rating determined based on a collection of customer characteristics.

The customer characteristics that are considered in assessing risk include: business and entity characteristics, geography and country characteristics, and product and transaction characteristics.

The risk model recognizes that customers engaged in certain businesses or entities pose a greater than normal risk of money laundering or terrorist financing. Typically, the higher risk businesses and entities are those that involve a high volume of cash activity. Cash intensive businesses sometimes allow launderers to disguise cash derived from illegal activities in deposits containing cash derived from regular, legitimate business activity. Cash intensive businesses include: casinos, gaming, money service businesses, broker-dealers. Also, government accounts (e.g., accounts of government corporations, countries or government agencies) pose a relatively high risk of money laundering activities due to the nature of activities of such organizations.

For an individual, examples of high risk business or entity characteristics can include: political exposure, association with a politically exposed individual, unknown sources of wealth, unknown primary source of income and maintaining an account at Pershing.

For a non-individual, examples of high risk business or entity characteristics can include: being an issuer or bearer of shares, being government sponsored and not having a physical location. Also being engaged in any of the following businesses can be a higher risk business or entity characteristic: restaurants, retail stores, parking lots, garages, hotels, motels, hedge funds, dealerships (for cars, boats or trucks), travel agencies, dealers (of jewels, gems or precious metals), importing, exporting, construction, real estate, broker dealers, casinos, gaming establishments, card clubs, money transmitters, off-shore subsidiaries, companies in tax havens, banks in high intensity drug trafficking areas, leather goods stores, telemarketing, wholesalers of consumer electronics, retailers of consumer electronics, textile businesses, sole proprietorships, little known firms (“gatekeepers”), art dealers, antique dealers, real estate brokers or agents, pawn brokers, auctioneers, ship operators, plane operators, bus operators, charitable and not-for-profit organizations. Other high risk characteristics for a non-individual include: the relationship with the customer is through a form of delegated authority, a bank employee has a direct relationship with the entity, the customer is associated with a politically exposed person, the customer is a foreign limited purpose entity, the customer is a foreign not-for-profit organization or the customer is a religious not-for-profit organization.

For a financial institution, examples of high risk business or entity characteristics include: the relationship with the customer is through a form of delegated authority, association with a politically exposed person, issuing bearer shares, no physical location, no public enforcement in customer's country of origin, considered an off-shore entity, correspondent banking, financial business type is either money exchange or foreign finance company.

The risk model also identifies several medium risk characteristics. In particular, for an individual, examples of medium risk characteristics include: employer is a governmental agency, has had an existing relationship with the bank for less than three months, formerly employed by a governmental agency, has close relationship with a government official, source of wealth is real estate, primary source of income or funds is real estate.

For a non-individual, examples of medium risk characteristics include: having had a relationship with the bank for less than three-months, a bank employee having a material position in the entity applying as customer and the customers legal type is either a foreign partnership, a not-for profit, a foreign trust, a foreign state or local government or a government agency.

For a financial institution, examples of medium risk business or entity characteristics include: having had a relationship with the bank for less than three months, having products that will be used for third party settlements and having an off-shore license.

The risk model also recognizes that certain geographical and country characteristics are relevant to assessing risk. In general, the risk model assesses risk based on whether the customer is located or operating in a country that lacks adequate anti-money laundering strategies. Typically, such countries are those: 1) where cash is the normal medium of exchange; 2) with a politically unstable regime and high levels of public or private sector corruption; 3) with high levels of drug production and/or transit; or 4) that have been classified as countries with inadequacies in their anti-money laundering strategies.

Generally, the risk model ranks countries as belonging to one of four categories: OFAC risk, high risk, medium risk or low risk. If customer information relates to an OFAC risk rated country, then an account for that customer cannot be set-up until further investigation about that customer is conducted. That further investigation is typically conducted by a compliance officer at the bank. A company related to a country deemed to be high risk demands special attention from the bank's compliance department because of the likelihood that the customer will engage in money laundering. A customer related to a country deemed to be medium risk does not need to be reported to the bank's compliance department. Nevertheless, that customer still represents a risk for money-laundering activities. A customer related to a country deemed to be low risk does not pose a significant risk of money laundering on that basis. However, there may be other reasons why that customer may be considered a risk.

Country risk classifications may be based on information from a variety of resources. For example, one resource is a Financial Action Task Force (FATF) list of countries considered risky from a money laundering or terrorist financing perspective. The FATF is an inter-governmental body whose purpose is the development and promotion of national and international policies to combat money laundering and terrorist financing. The FATF is a policy-making body that works to generate the necessary political will to bring about legislative and regulatory reforms in these areas. The FATF has published numerous Recommendations in order to meet this objective.

Other resources for identifying country risk classifications include: the United State's Patriot Act, which designates certain countries as primary money laundering concerns and the Organisation for Economic and Cooperative Development's (OECD) list of countries having poor tax practices. The OECD is a group of member countries sharing a commitment to democratic government and the market economy. Other resources for identifying country risk classifications include: the U.S. government's list of drug producing and drug conduit countries, the U.S. government's list of state sponsors of terrorists, the U.S. State Department's annual report on country money laundering risk and global terrorism, and the bank's internal country risk management ratings.

A complete list of geographical locations, countries and their corresponding risk ratings are generally maintained within the system itself. The system is set up so that information is periodically updated. Alternatively, other systems may be accessed for such information.

For a customer who is an individual, the following geographical characteristics are relevant to determining risk: country of birth, legal country, legal region, mailing country, mailing region, other country, other region, country of primary citizenship, country of additional citizenship, country of source of wealth, country of primary source of income, country of other source of income, country where income is derived, country of employer, anticipated countries where transactions will be going to or coming from, etc.

For a customer who is a non-individual and not a financial institution, the following geographical characteristics are relevant to determining risk: legal country, legal region, mailing country, mailing region, other country, other region, country of registration or incorporation, country control, country of parent/holding company, control country of subsidiary, country of affiliate, country of source of equity or capital, primary country where activity is conducted, anticipated countries where transactions will be going to or coming from, etc.

For a customer who is a financial institution, the following geographical characteristics are relevant to determining risk: country where off-shore license was issued, legal country, legal region, mailing country, mailing region, other country, other region, country of registration or incorporation, control country, country of source of equity or capital, primary country where customer's activity is conducted, country where customer derives revenue, anticipated countries where transactions will be going to or coming from, etc.

The risk model also recognizes that a customer's involvement with certain products and/or transactions is relevant to assessing risk. In general, products and services with high risk are those where unlimited third party funds can be freely received, or where funds can be paid to third parties without evidence of identity of the third party being taken. A high risk product or service typically supports high speed movement of funds and might conceal the source of those funds.

In one implementation, the system supports three main banking products: Demand Deposit accounts (DDA), Negotiable Order of Withdrawal (N.O.W.) accounts and money market accounts. The system could, of course, be adapted to support other kinds of banking products as well. The above types of accounts are generally considered low risk in the U.S. High risk products and/or services include those involving foreign cash. Medium risk products and/or services are those involving debit cards, trade finance, ebanking and negotiable instruments.

Assuming no OFAC hits are identified, after assigning risk ratings to individual pieces of customer data according to the foregoing techniques, the system determines an overall risk rating for the customer based on the following algorithm. If consideration of the individual pieces of customer data resulted the assigning of all low risk ratings, then the system assigns an overall risk rating for the customer of low. If at least one high risk rating was assigned to an individual piece of customer data, then the system assigns an overall risk rating for the customer of high. Otherwise, the system assigns a medium overall risk rating for the customer.

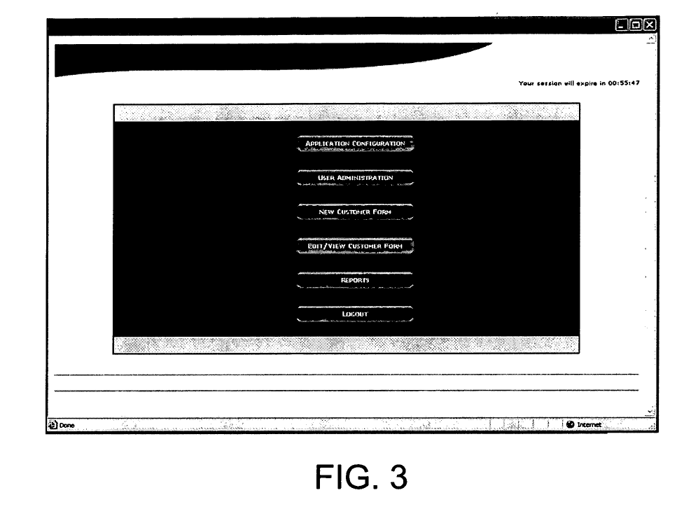

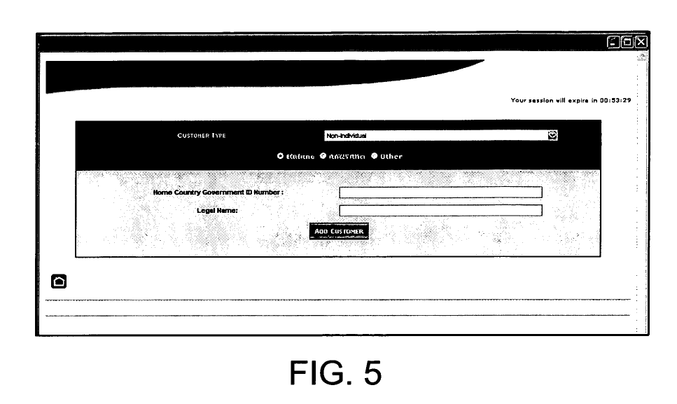

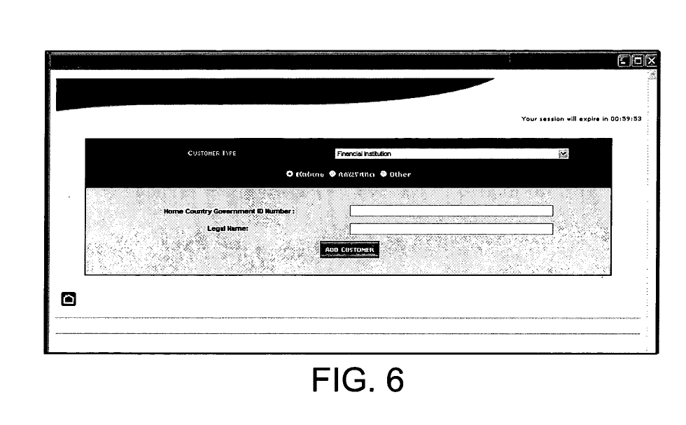

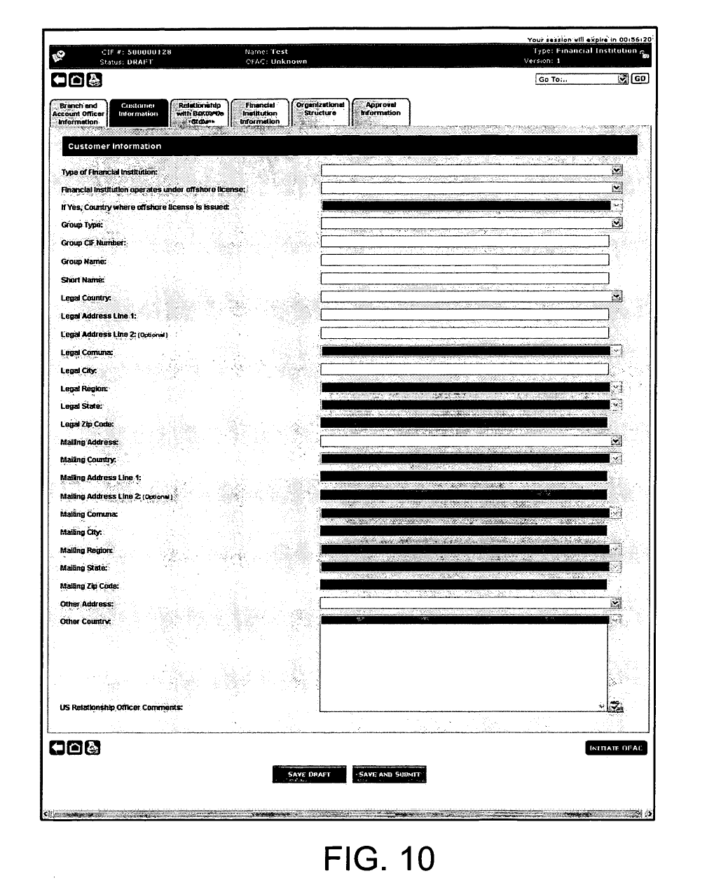

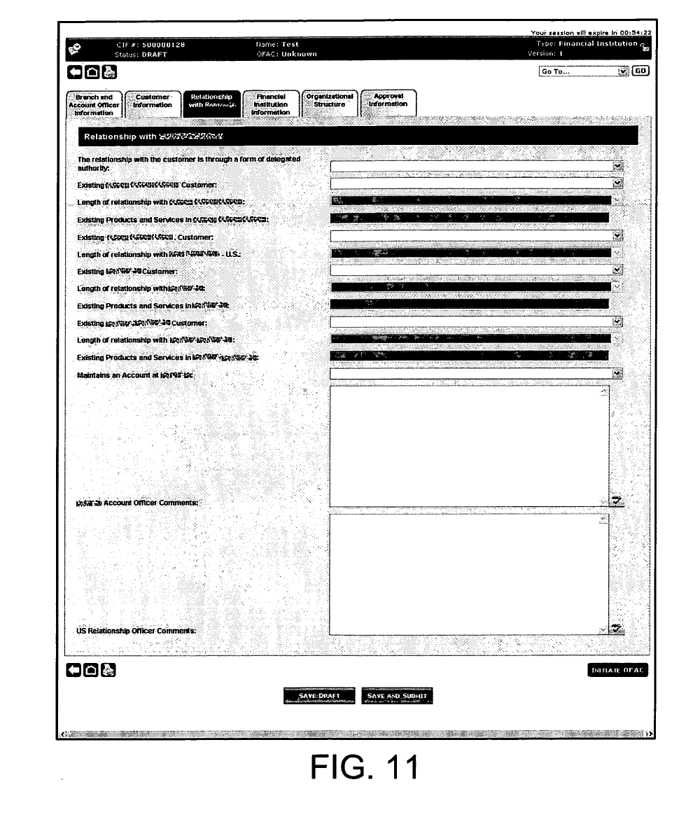

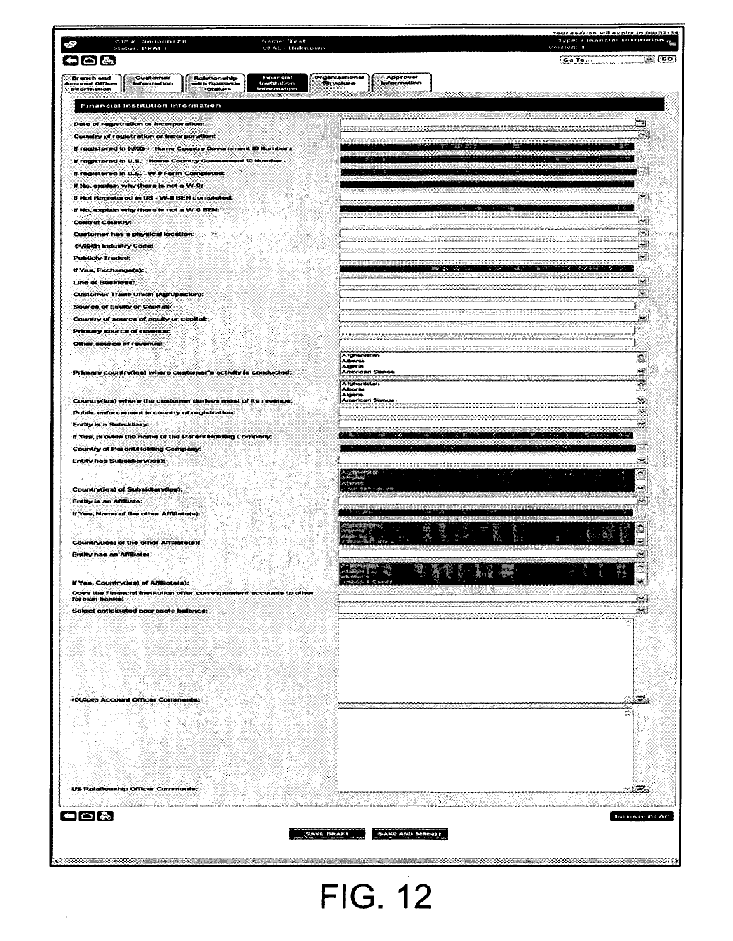

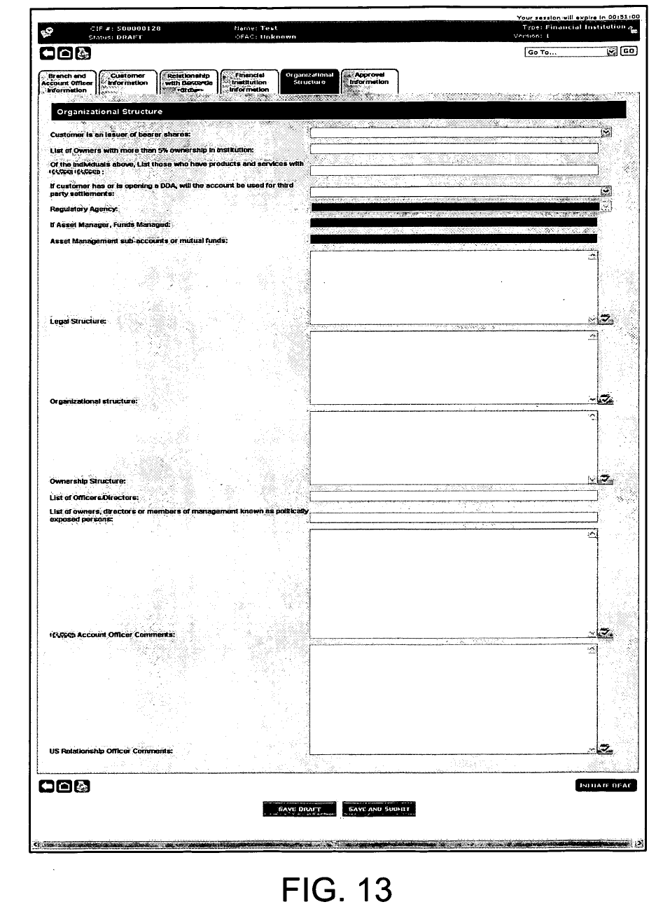

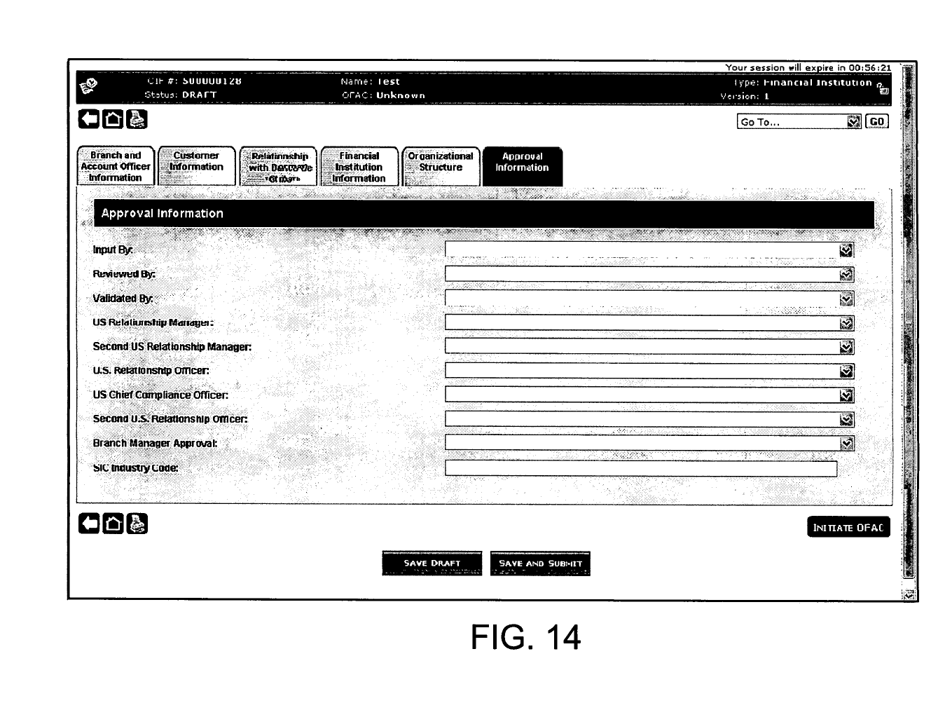

FIGS. 3A-45 disclose screens that are presented at a computer system's graphical interface. The graphical interface is coupled to a processing unit and a memory storage unit. The screens represent certain aspects of a particular implementation of the techniques and methods disclosed herein. The illustrated screens may be presented to a user through a browser and, therefore, may include typical functionality associated with navigating in a browser. That functionality may include navigating to a previous screen, navigating to a subsequent screen, returning to a designated home page, or other functionality.

Various information is entered by a user accessing the screens shown in the following figures. It should be understood that the exchange of information between a user and the application can be implemented in a variety of ways including, but not limited to, selecting information from a dropdown menu, filling in an empty text box, clinking on a button (or other type of) link. Although the figures show certain information being exchanged in certain ways, the figures are intended to be exemplary only and not limiting.

A user typically accesses the system through a login screen. The login screen enables a user to enter a username and password to access the application. The login screen also enables a user to select a language that will be used in accessing the application. In one implementation, English is set as the default language and Spanish is offered as an option. Other languages may be provided as options or defaults as well. In one implementation, a Windows® authentication process is used to facilitate the login process.

In one implementation, the application utilizes a layered security model that allows fine granularity at the Application level. Such a model enables functions of the application to be enabled or disabled for different users. The model utilizes a framework of managed roles and security objects to provide different security roles all the way down to the actual objects contained on individual web pages of the application. As the user navigates the tool, certain navigation links are enabled/made visible based on the user's assigned roles.

Such functionality may relate, for example, to customer validation. In a particular implementation, high risk customers may need to be reviewed and validated by three different users, such as the head of DDU, the U.S. chief compliance officer or a branch manager. In that scenario, all three of the aforementioned individuals, in order above, must access the system and create a compliance verification form and explicitly validate the customer before the customer data is imported into Datapro™.

In the exemplary implementation, medium risk customers must be reviewed and validated with CDD by two users, such as a relationship officer lead or the head of DDU. In that scenario the two aforementioned individuals, in the order above, must go into CDD and create a compliance verification form and explicitly validate the customer before the customer data is imported into Datapro.

In the exemplary implementation, low risk customers must be reviewed and validated within CDD by the following people, for example, a relationship officer lead.

Once a proper user name and password are entered, the user can select a “submit” link to advance to a main menu of links, the selection of which enables a user to access various functionalities associated with the application. An exemplary main menu screen is shown in FIG. 3. The particular links shown in the illustrated implementation include: “application configuration,” “user administration,” “new customer form,” “edit/view customer form,” “reports” and “logout.”

In certain implementations, the links presented on a main menu screen may depend on the role(s) of the user who has logged into the system. So, for example, the application might allow a particular user to access only functionality that is associated with the “new customer form,” “edit/view customer form” and “reports” links on the main menu page. In that situation, the application might recognize the user upon login and present a main menu screen that includes only “new customer form,” “edit/view customer form” and “reports” links.

From the main menu screen, selecting the “new customer form” link causes the application to provide access to functionality associated with adding a new customer to the application's database. When a new customer is to be added, the application prompts the user to identify what type of customer is being added. Examples of customer types include individuals, non-individuals and financial organizations. The system also prompts the user to specify the new customer's nationality or citizenship in order to determine the unique identifier the system will associate to the customers. For example, if the customer is a U.S. citizen, the system will require a social security number or tax identification number.

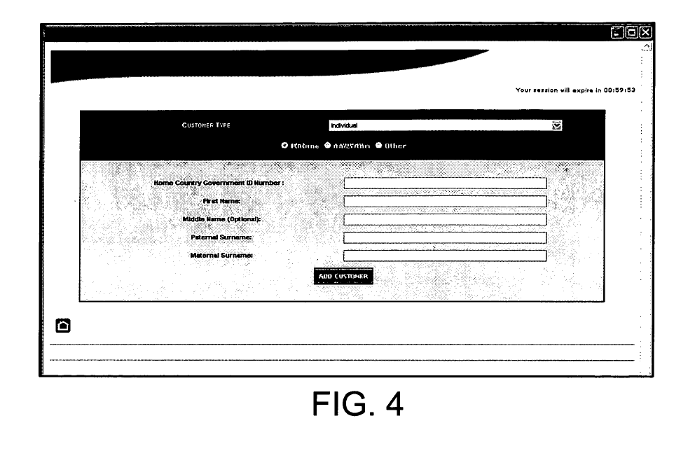

Once the user enters a new customer type and nationality or citizenship, the application presents the screen of FIG. 4, 5 or 6, depending on the type of customer being added. Each of those screens prompts the user to enter particular kinds of data depending on the type of customer being added.

For example, if the customer being added is an individual, the application prompts the user to enter the individual's home country government identification number (e.g., a social security number, driver's license number or passport number), the individual's first and (optionally) middle names, as well as the individual's paternal and maternal surnames. Alternatively, if the customer being added is a non-individual (e.g., a corporation, a partnership, a non-profit organization), the application prompts the user to enter the non-individual's home country government identification number (e.g., a tax identification number) and legal name. If the customer being added is a financial institution, the application prompts the user to enter the financial institution's home country government identification number (e.g., a tax identification number) and legal name.

The application may be adapted to prompt the user for other information related to the new customers beyond the information that is specifically set forth above. Once the user has entered the information he or she has been prompted to enter, the “add customer” link can be selected from any of the screens of FIG. 4, 5 or 6.

If, from the main menu screen, the user selects the “edit/view customer” link, the application presents the screen of FIG. E. That screen enables the user to search for existing customers and open a customer's form in order to view information related to customers that have been entered into the application. The illustrated implementation enables the user to search by CIF number, customer name, identification number, version, status, portfolio group and customer status. Once a search is conducted, results of the search are presented in the form of a list. Each row of the list indicates a form (i.e., a collection of data for a particular customer) that matches the search terms used in the search

Generally, customer information is stored in a form called a customer due diligence form (i.e., a “CDD form” or a “form”). In one implementation, after a CDD form has been created and validated, if changes need to be made or new information added, a new version of the CDD form is created. For example, if a validated first version of a CDD form exists for a particular customer, and a user wants to update the address of this customer, the user will need to create a second version of the CDD form for the customer. Once the changes are validated the CDD form will be a validated second version.

The CIF number is a unique number that is assigned to each customer. The customer name is the name as written when creating a form. ID Number is the home country's government identification number. The version is the sequential iteration of customer information that has been stored for a particular customer.

Status refers to a customer's current status within the drafting/approval process. In certain implementations, a customer's status may be indicated as “draft,” “draft rejected,” “pending validation,” or “validated.” In such implementations, a “draft” status indicates that the customer's profile is being drafted (i.e., information about the customer is being collected and entered into the application) and has not been submitted for approval. A “draft rejected” status indicates that the customer's profile has been reviewed and rejected by the reviewer. If a customer's profile has been rejected, the customer information can be revised and resubmitted for approval, if so desired. A “pending validation” status indicates that the customer's profile has been submitted for approval and is pending validation. A “validated” status indicates that the customer's profile has been validated and that the information has been sent to the institution's core banking system.

A portfolio group is a group of customers associated with a particular user or users. In one implementation, the application provides users the ability to add information to profiles of customers within their own portfolio groups and the ability to read only all other customers.

Customer status field can be either open or closed. In one implementation, the CDD forms of customers having open status can be modified by users having appropriate clearance. Generally, the CDD forms of closed customers cannot be changed.

The illustrated implementation includes a list of potential OFAC list hits for a search that has been conducted. The illustrated list includes several columns headings including CIF number, customer name, identification number, customer type, version, latest status and last updated. The far left column of each row in the list includes a “go” link that, if selected, will present additional data about the customer identified in that row.

The application enables a user to sort or filter the list in a number of ways. In one implementation, the list is initially sorted by the last updated date, beginning with the most recent. However, if a user wants to resort the list so that the data will be presented in a different order, the user can click on an appropriate header of one of the columns. That action will cause the data to be resorted in an ascending order according to the data listed in the column beneath the clicked header. Alternatively, the user can click a selected header twice to sort all the records in a descending order based on data entries in the column beneath the selected header.

In the illustrated implementation, customers data can be sorted by either CIF Number, Customer Name, ID Number, Version, Status, Portfolio Group or Customer Status.

This section allows the user to filter through all the records to find any specific record. The user can filter on multiple fields. One way that a user can use the system's filtering functionality is to select one or more values that are presented in one or more of the dropdown boxes. Once the user has selected the values, the user can click on the filter icon. In response, the system filters the customer data accordingly. For example, if the user wants to view open customers with the status of pending validation, the user can select “open” from the customer status dropdown box and “pending validation” from the status dropdown box. The user then can click on the filter icon to prompt the system to filter. The system then filters the customer data to present a list of only open, pending validation customers.

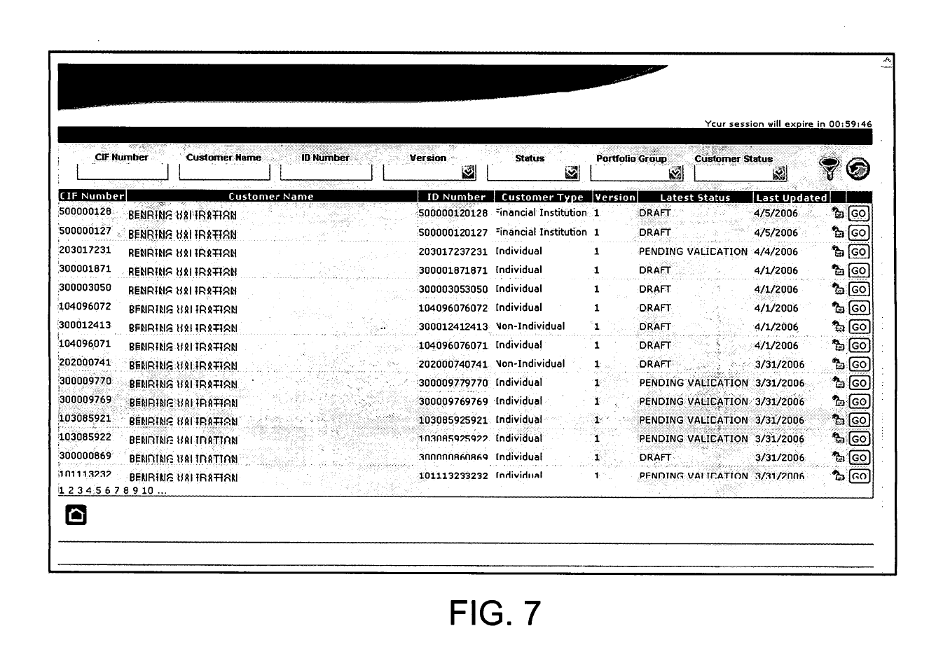

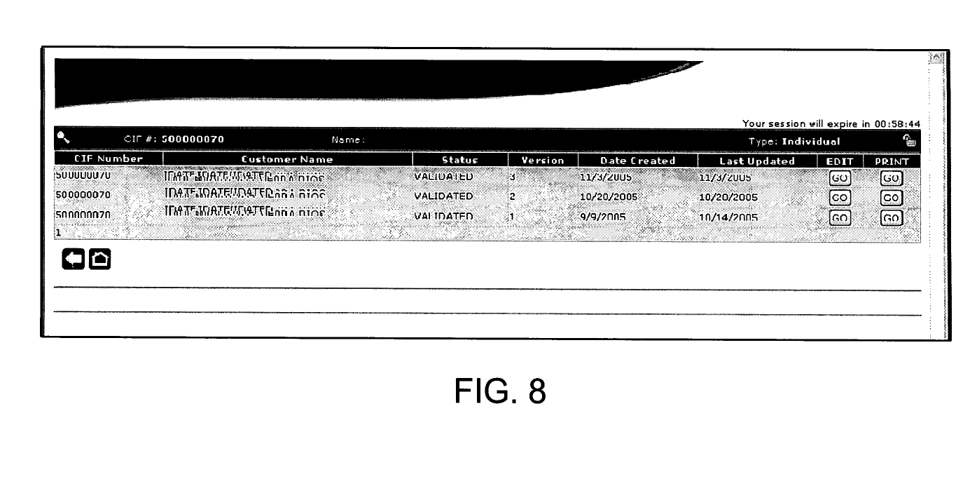

If a “go” link in the far left column of the screen of FIG. 7 is selected, the application presents the screen of FIG. 8. That screen lists various versions of a particular customer form that have existed. From that screen, a user can either edit or print information about a selected version. “Go” links are provided to enable that functionality (i.e., either edit functionality or print functionality) in the two columns on the right side of the list.

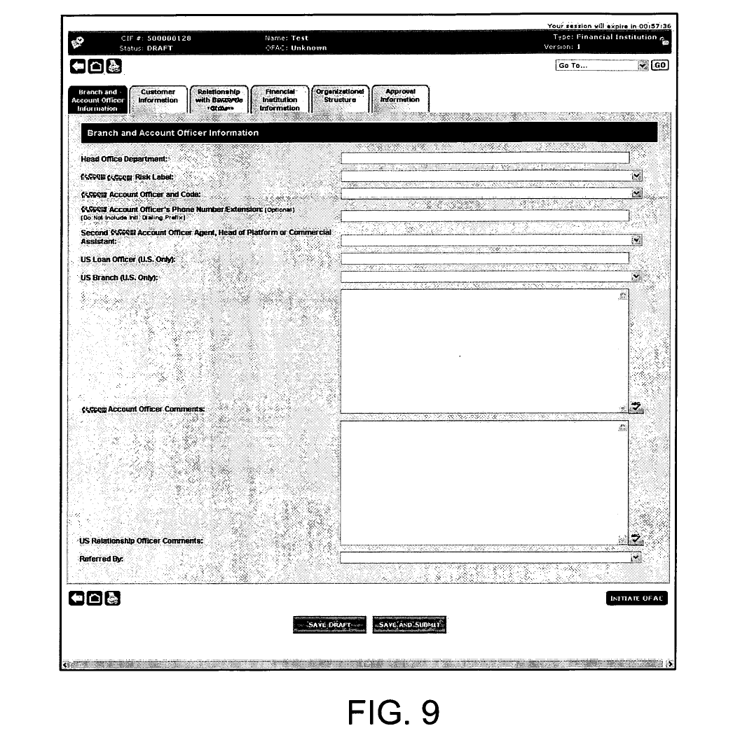

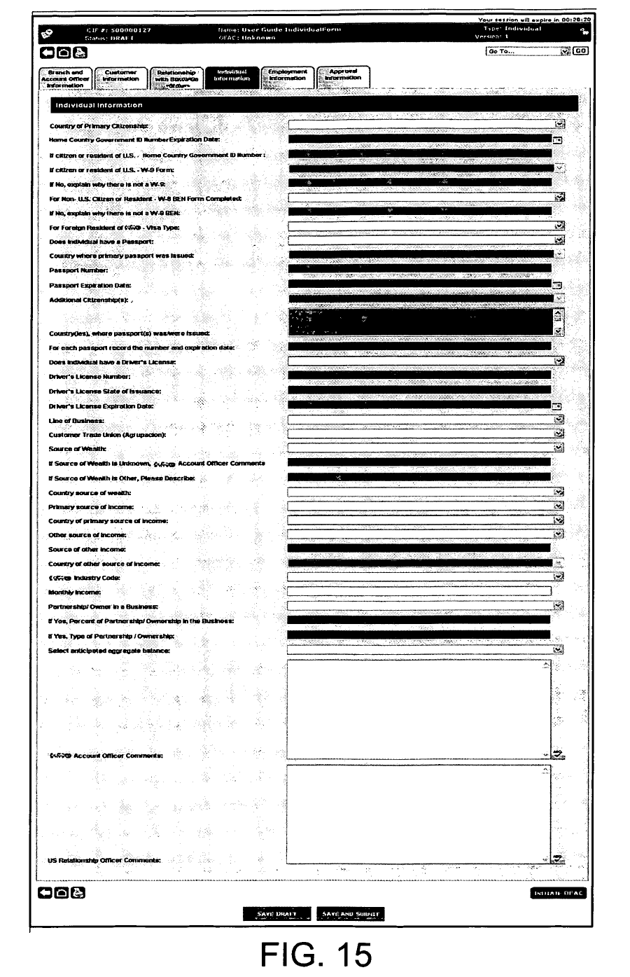

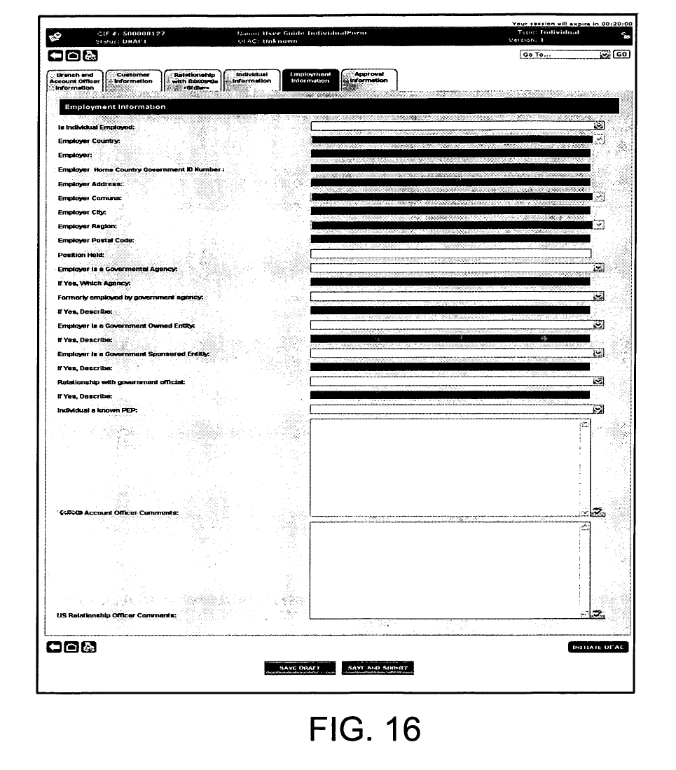

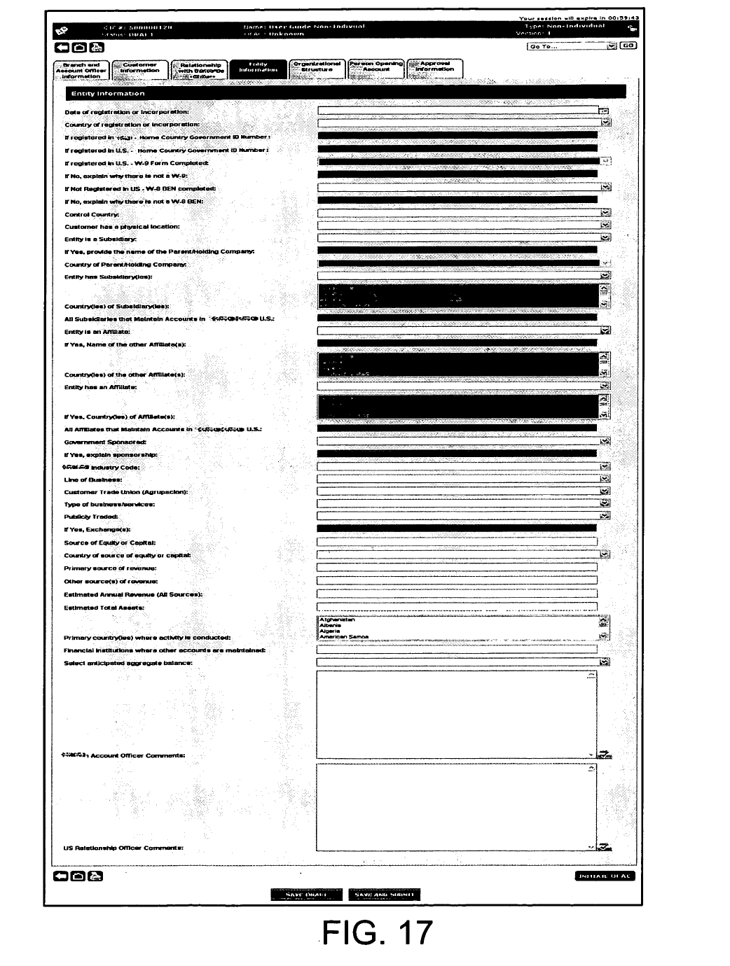

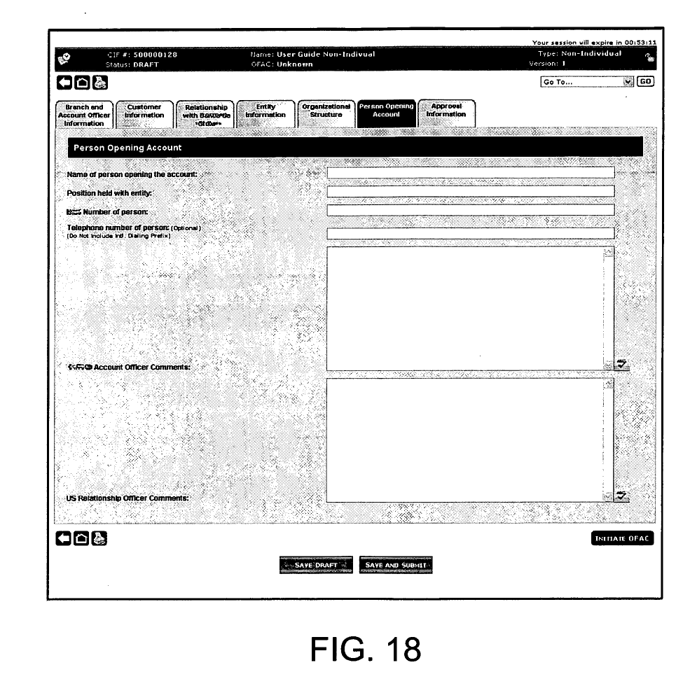

Selection of a “go” link under the edit column causes the application to present screens that enable a user to edit information associated with the selected customer. The type of customer whose data is to be edited determines the screen (or set of screens) that the application enables a user to access. The application presents different screens depending on whether the customer is a financial institution, an individual or a non-individual. Some of the screens for a financial institution are shown in FIGS. 9-14. Some of the screens for an individual are shown in FIGS. 15 and 16. Some of the screens for a non-individual, non-financial organization are shown in FIGS. 17 and 18.

A number of tabs are provided at the top of the screens of FIGS. 9-18. The selection of a given tab causes the application to present a different set of data related to the selected customer. The tabs enable a user to navigate between screens that include different sets of data.

For example, if the selected customer is a financial institution, the tabs (in FIGS. 9-14) include a “Branch and Account Officer Information” tab, a “Customer Information” tab, a “Relationship with Customer” tab, a “Financial Institution Information” tab, an “Organizational Structure” tab and an “Approval Information” tab. If the selected customer is an individual, the tabs (in FIGS. 15 and 16) include a “Branch and Account Officer Information” tab, a “Customer Information” tab, a “Relationship with Customer” tab, an “Individual Information” tab, an “Employment Information” tab and an “Approval Information” tab. If the selected customer is a non-individual, non-financial institution, the tabs (in FIGS. 17 and 18) include a “Branch and Account Officer Information” tab, a “Customer Information” tab, a “Relationship with Customer” tab, an “Entity Information” tab, an “Organizational Structure” tab, a “Person Opening Account” tab and an “Approval Information” tab.

Each of the screens shown in FIGS. 9-18 identify exemplary information that might be considered relevant in assessing the risk of a particular customer. Information other than that specifically identified may also be considered relevant. The application is adapted to be easily changed so that appropriate information is obtained and applied to the application's risk model.

At the bottom of each of the screens shown in FIGS. 9-18 is an “initiate OFAC” link. Selection of that link initiates a checking process in conjunction with Office of Foreign Assets Control (“OFAC”) requirements. In one implementation, making such a selection causes the application to interface with a third-party OFAC checking system. In another implementation, the application itself includes OFAC checking capabilities. The OFAC is the branch of the US Department of the Treasury that administers and enforces economic and trade sanctions based on US foreign policy and national security goals against targeted foreign countries, terrorists, international narcotics traffickers, and those engaged in activities related to the proliferation of weapons of mass destruction. An “initiate OFAC” link is provided at other screens as well.

Once an OFAC check has been initiated for a customer, the OFAC status will appear in the header of the screen and an OFAC status button will be available at a bottom right hand corner of the page. The OFAC status in the header can be clicked to view more details about any OFAC hits that may have been detected. As an example of an OFAC hit, the OFAC watch list that is checked might identify a particular country (e.g., Iran) as being non-compliant with OFAC requirements. In that situation, if a potential customer from Iran is entered into the system, the system will recognize that an OFAC match exists and will notify the user to take appropriate actions.

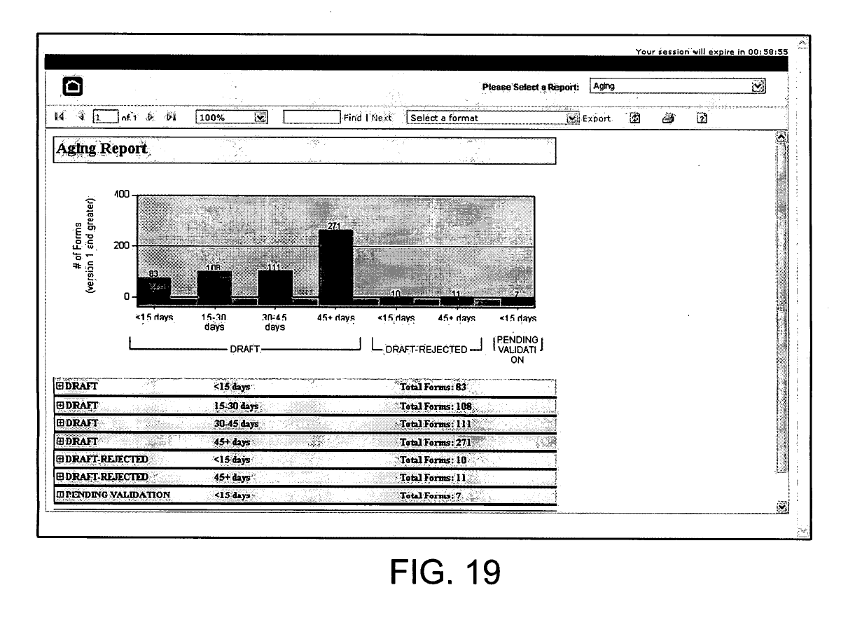

Referring to the main screen of FIG. 3 again, selection of the “Reports” link causes the application to provide access to various report screens, such as those shown in FIGS. 19-32. Each of the report screens includes a dropdown menu at an upper right corner of the report screen. That dropdown menu provides a list of available reports that are available for a user to access. A user can navigate between those various report screens by making selections from that drop-down menu.

FIG. 19 is a screen that shows an aging report. The aging report indicates how long each form (of customer information) has been in each non-validated state. That information is presented both in bar graph format (in the upper half of the screen) and in list format (in the lower half of the screen). The states indicated in the illustrated implementation include “draft,” “draft-rejected” and “pending validation.”

The list format portion of the aging report provides an option to drill down and identify the particular forms that exist in each state. By selecting a plus symbol (“+”) that is adjacent a particular entry, the user causes the application to identify the particular forms that exist in each state. When the plus symbol next to a list entry is selected, the application provides a list of those forms beneath the corresponding entry.

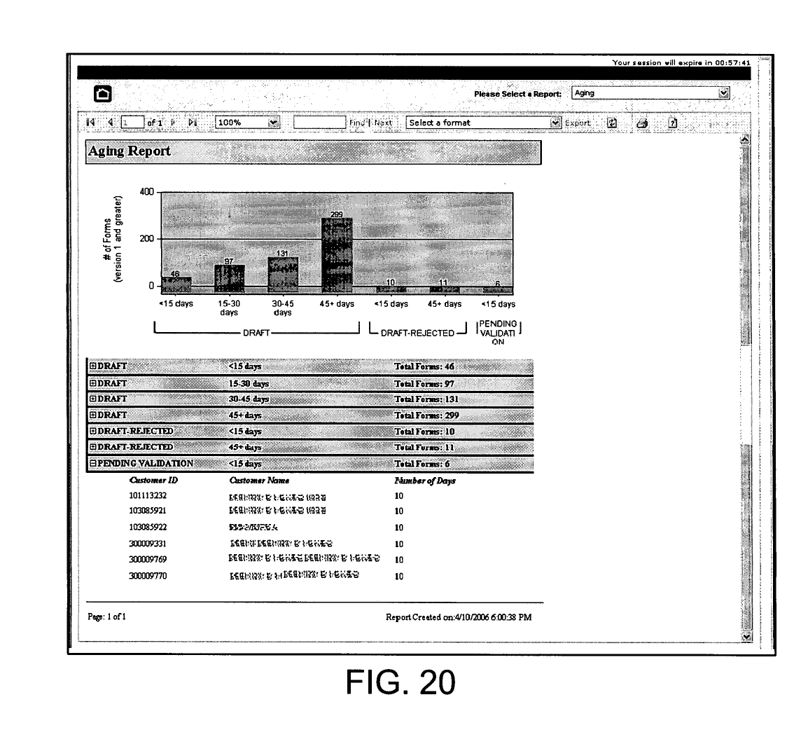

An example of that is shown in FIG. 20 which shows a screen after a user has selected a plus symbol next to the bottom list entry which identifies that a total of six forms have been “pending validation” for less than 15 days. Beneath that list entry, the six forms are identified by a customer number, customer name and the exact number of days that the form has been “pending validation.”

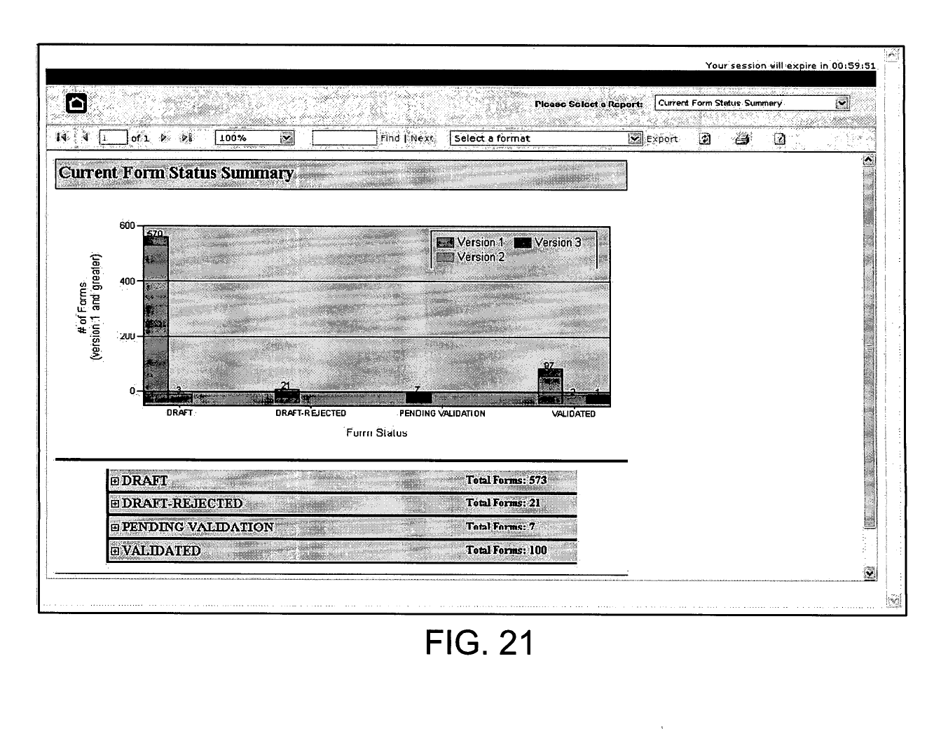

FIG. 21 shows a current form status summary that indicates the number of current forms in each state. The information is provided both in bar graph format (in the upper half of the screen) and in list format (in the lower half of the screen). The states indicated in the illustrated implementation include “draft,” “draft-rejected,” “pending validation” and “validated.” Shading is provided in the bar graph portion of the screen to indicate what portion of the forms in a particular state are first, second or third versions of the form. Any number of versions may exist for different customers. The system identifies how the versions for a particular customer differ from each other. The bar graph portion of the report also provides an actual count of the number of forms in each category.

The list format portion of the current form status summary report provides an option to drill down and identify the particular forms that exist in each state. By selecting a plus symbol (“+”) that is adjacent a particular entry, the user causes the application to identify the particular forms that exist in each state. When the plus symbol next to a list entry is selected, the application provides a list of those forms beneath the corresponding entry. Also, the total number of forms in each state are indicated in the list portion of the report.

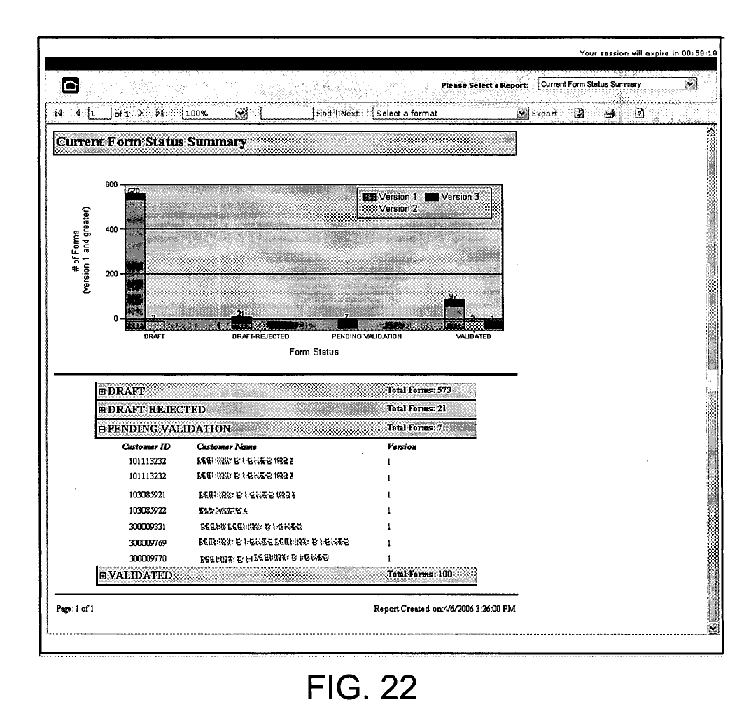

The screen in FIG. 22 shows a current form status summary report, in which the “pending validation” section of the list has been expanded. Each of the forms that have a status of “pending validation” are listed beneath that heading. Those forms are identified by customer identification numbers, customer names, and version numbers.

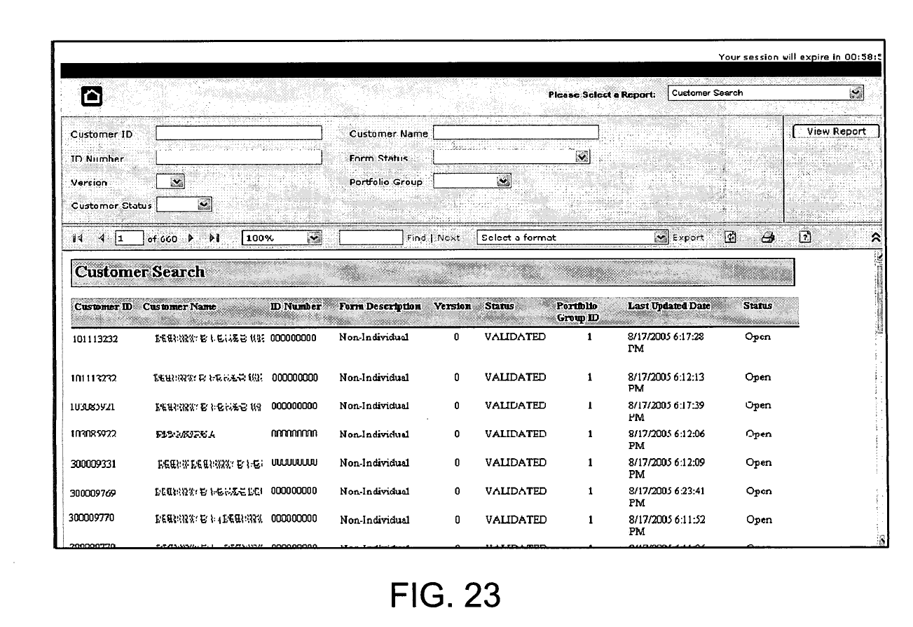

The screen of FIG. 23 is a customer search report. The illustrated screen includes functionality that enables a user to search for customers having particular characteristics. From that screen, a user can search using any of the indicated parameters of combinations thereof. The indicated search parameters include customer identification number, customer name, identification number, form status, version number portfolio group and customer status (e.g., open or closed). In some implementations, the database can be searchable based on other parameters as well.

Once a list of search results is generated, the list can be sorted according to any of the characteristics identified in the column headings. In one implementation, a user might, for example, sort the illustrated list according to the portfolio group that each customer entry belongs to by clicking on the word “portfolio group ID” at the head of the corresponding column.

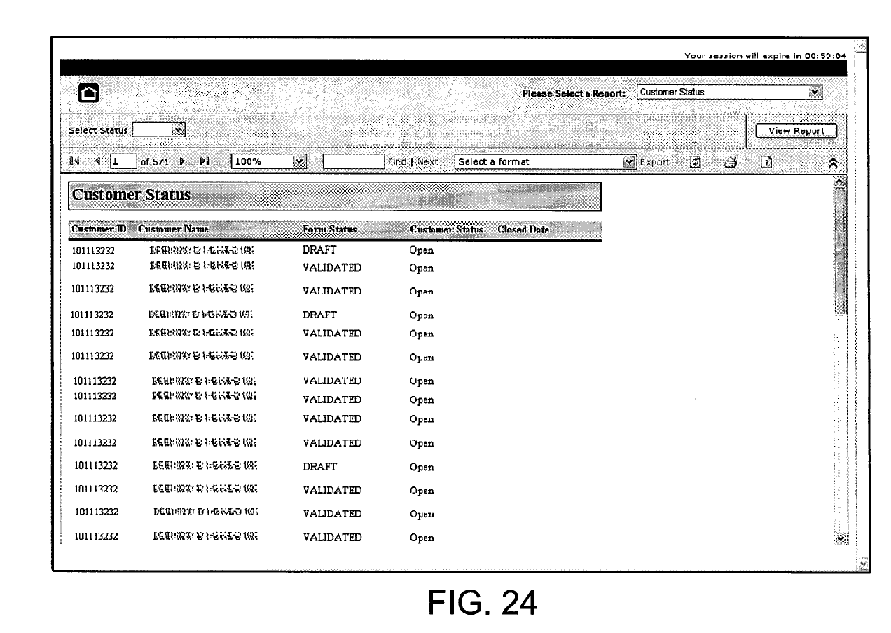

The screen in FIG. 24 is a customer status report. The customer status report shows the status of each customer. The illustrated list of customers can be sorted according to any of the column headings indicated by clicking on the appropriate column heading. For example, a user might sort the list of customers according to customer status, by clicking on the column heading “customer status.”

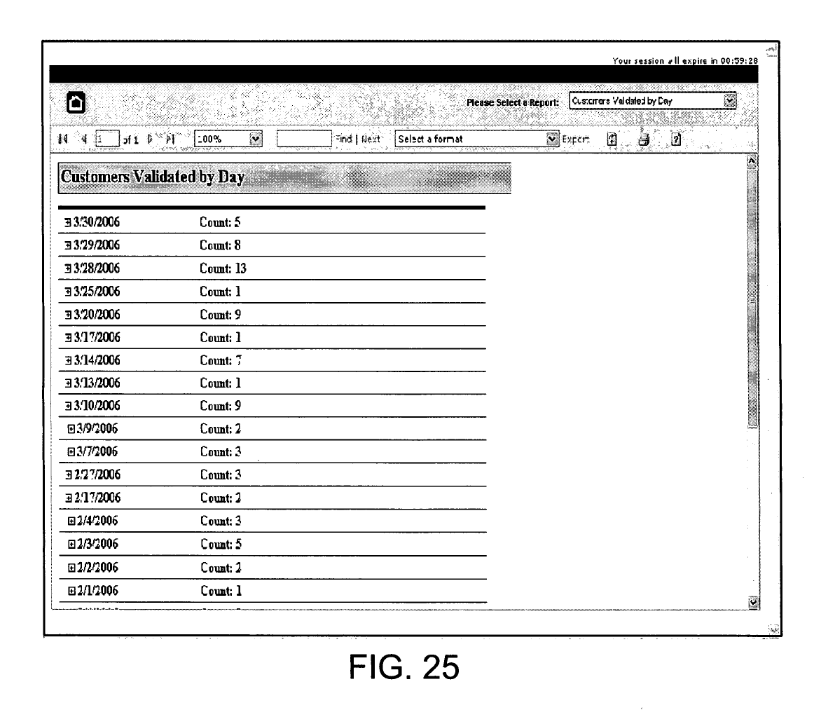

The screen of FIG. 25 is a report showing the number of customers validated by day. In the illustrated report, for example, on Mar. 14, 2006, seven customers were validated. The report provides drill-down capability to display the names and other information related to the customers that were validated on each particular day. That functionality can be accessed, for example, by clicking on a plus sign at a left side of an appropriate column.

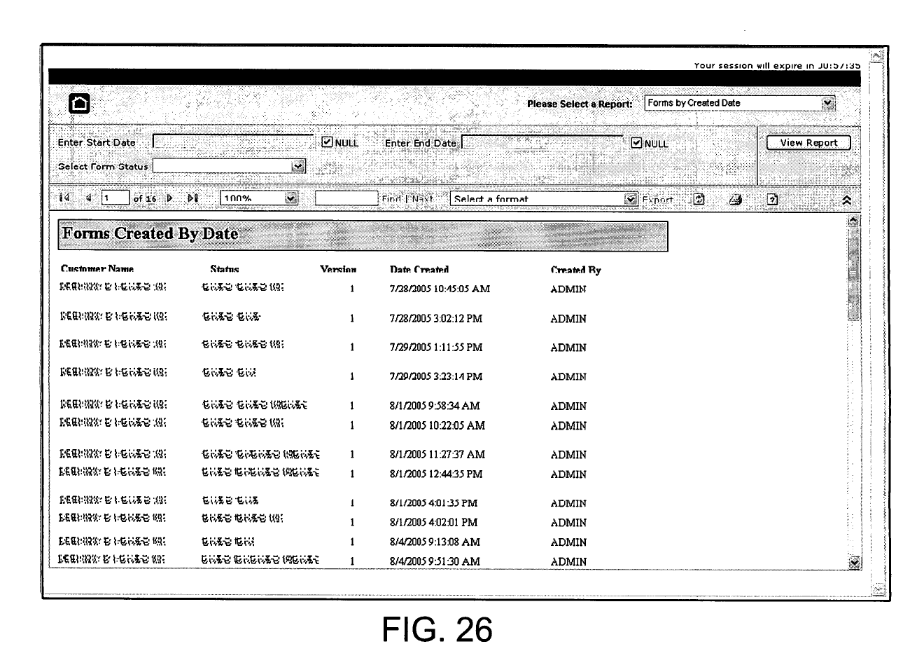

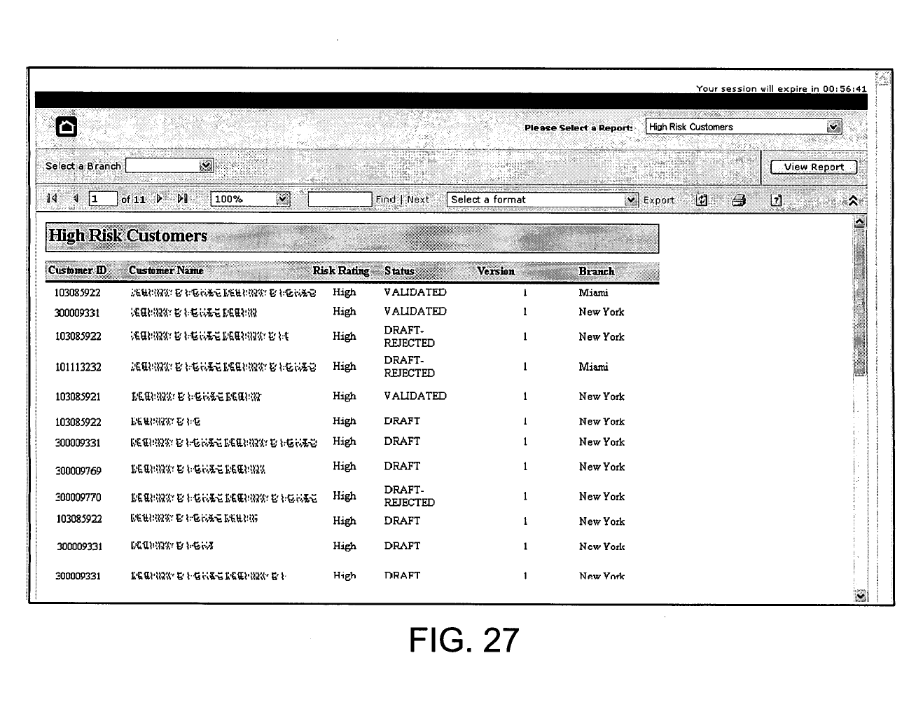

The screen of FIG. 26 is a report of forms created by date. From that screen a user can prompt the application to generate a list of forms that were created between two particular dates. That list may be further filtered to display only those forms that are currently in a specific state.

The screen of FIG. 27 is a report of high risk customers. The report provides a list of customers that the application has determined to be high risk. The report provides information about those high risk customers, including customer identification number, customer name, risk rating, status version and branch. The report can be filtered to show only high risk customers in a specific branch. Other filtering may be implemented.

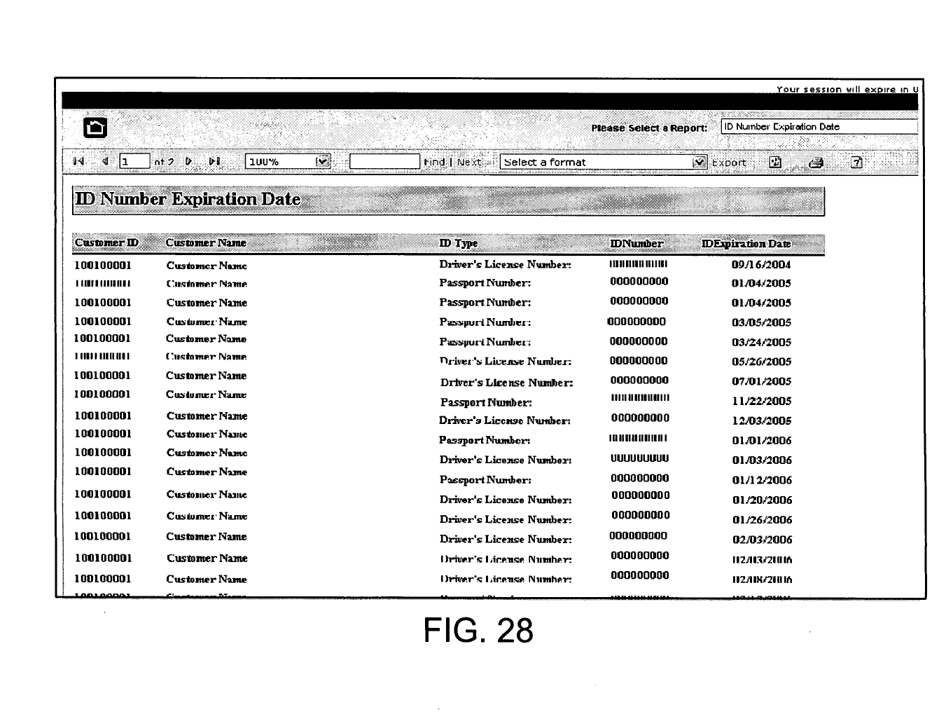

The screen of FIG. 28 is a report on identification number expiration dates. That screen displays the home country government identification numbers that have expired or soon will expire (e.g., within the next 30 days). In one implementation, the already expired identification numbers are listed first and indicated in a red font. In such an implementation, the soon-to-be-expired identification numbers are listed below the already expired numbers and are indicated in a black font. Other methods may be implemented to provide a way of easily distinguishing the already expired numbers from the soon-to-be-expired numbers.

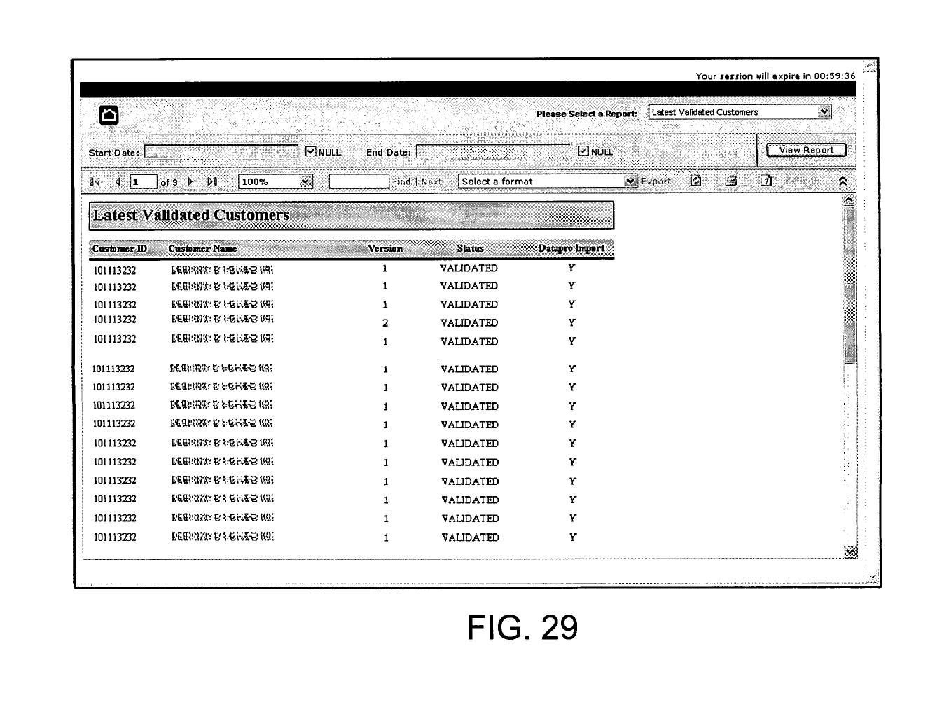

The screen of FIG. 29 is a report that shows the latest validated customers along with the most recently validated form version number. Other information provided with that report includes customer identification numbers, customer names, status of each customer and datapro import information. That report can be filtered to show only those customers that were validated between two specific dates.

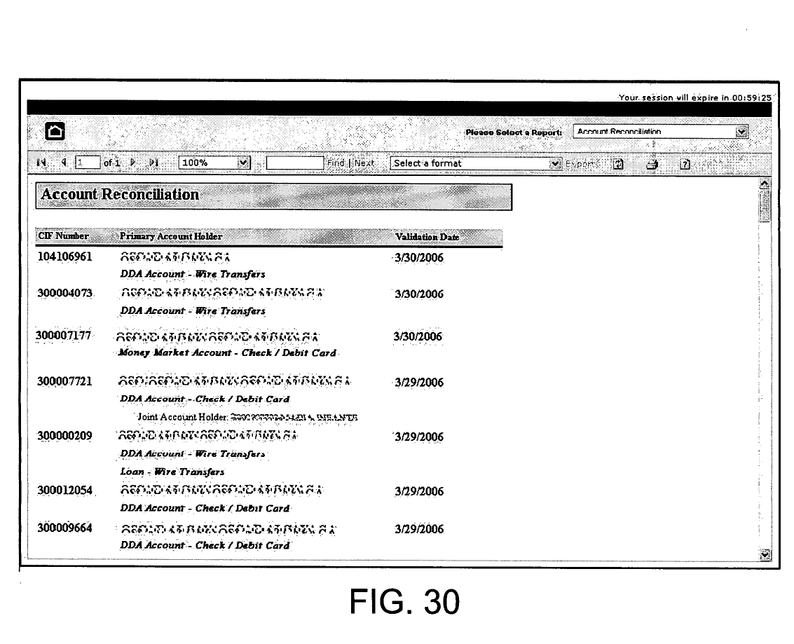

The screen of FIG. 30 is an account reconciliation report. That report provides a list of all validated customers along with product information for those customers. The report also indicates joint account holders, if applicable. Also provided are validation dates for each account identified.

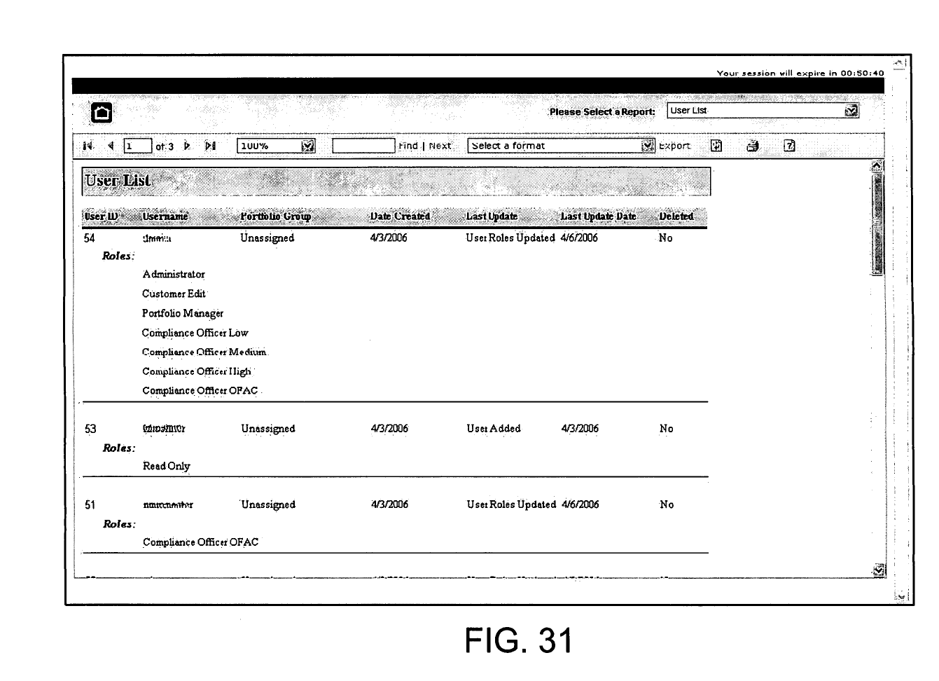

The screen of FIG. 31 is a user list report. That report identifies all users within the application. It provides information about their roles within the application, portfolio group, date created, date of last password change, whether the user has been deleted and, if so, the date of deletion.

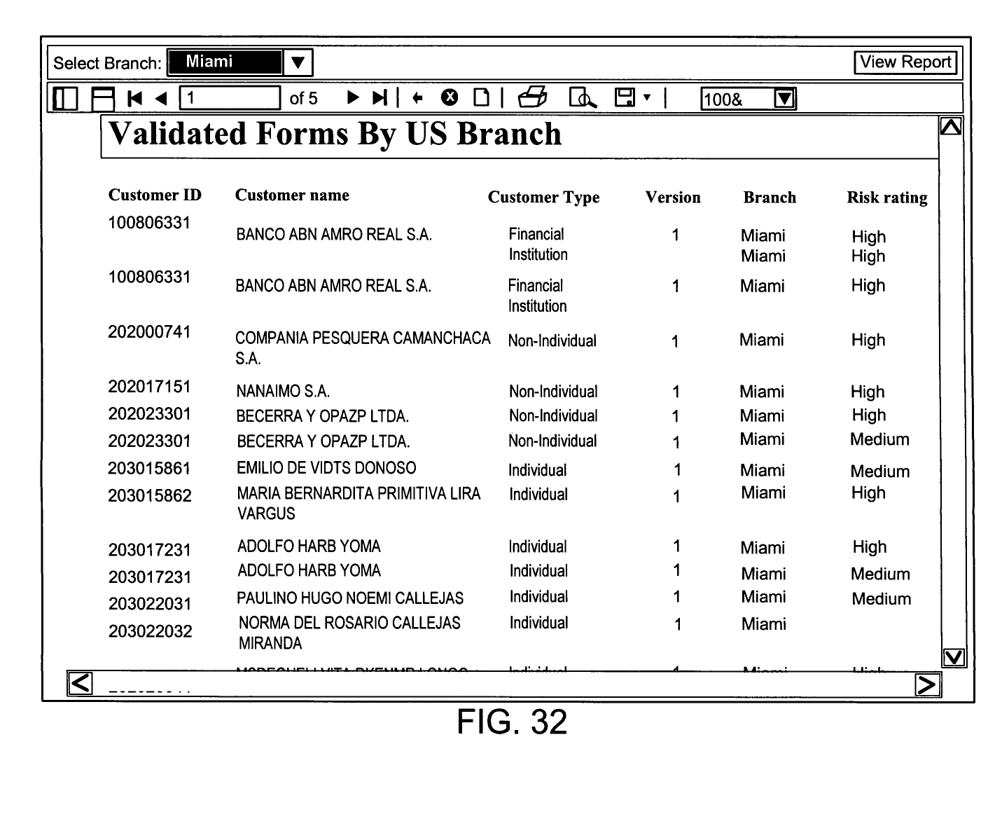

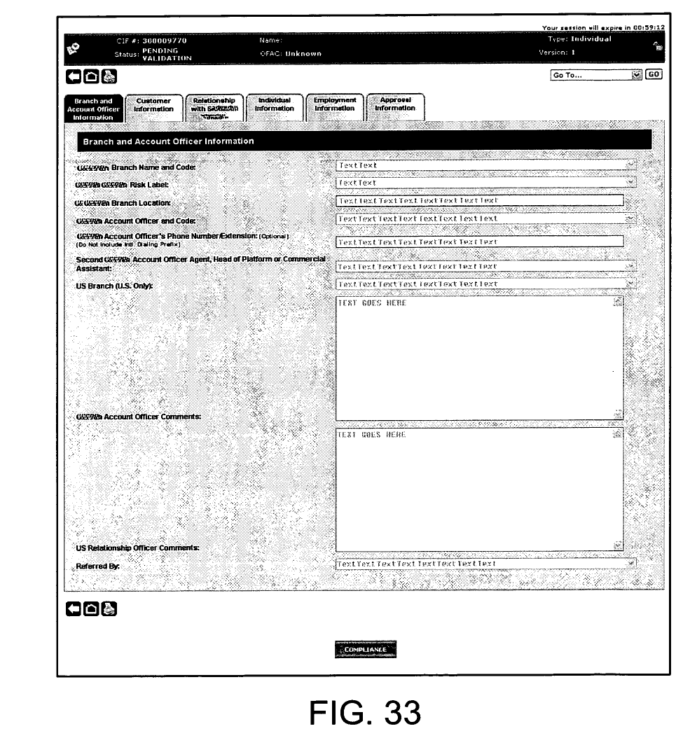

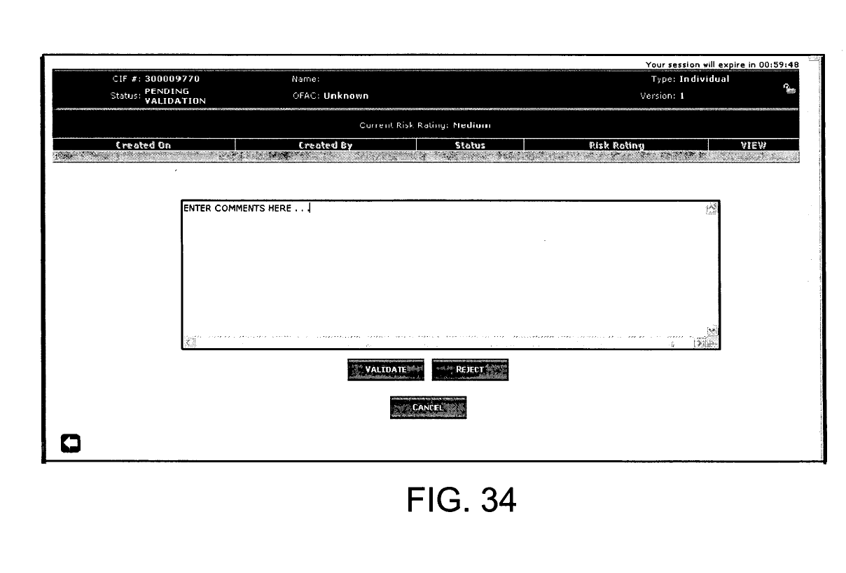

The screen of FIG. 32 is a report that identifies validated forms and which U.S. branch each form belongs to. The report can be filtered to show only those forms associated with a particular branch or branches. Referring now to the screen of FIG. 33, if a particular customer has a “pending validation” status, a compliance button is provided at the bottom of editing or informational screens associated with that customer. Selection of that compliance button prompts the system to present a set of screens related to compliance verification. The section of screens enables a user to access a customer verification form to either validate or reject a customer.

The screen of FIG. 34 is a compliance verification form. An area is provided to enable a user to enter comments about a customer. A “validate” button and a “reject” button are provided on that screen. If the user selects the “validate” button, the customer's status changes from “pending validation” to “validated.” If the user selects the “reject” button, the customer's status changes from “pending validation” to “draft-rejected.”

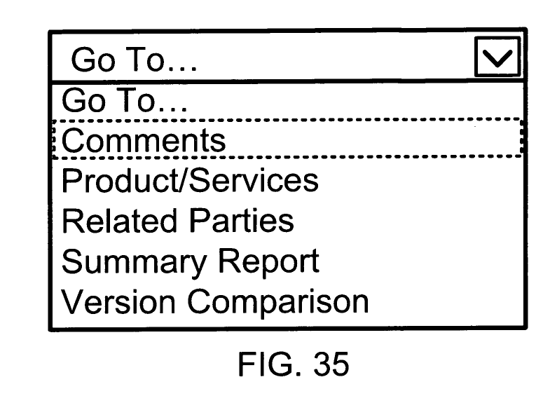

FIG. 35 shows an expanded dropdown menu that appears on several screens. For example, the dropdown menu appears in an upper right hand corner of the main form of every customer. From the dropdown menu, a user can add/view comments, add/view products and services, add/view related parties, view a summary report for the current form, or compare two versions of forms for that customer.

The application also is adapted to enable particular users to enter new comments to a customer's profile at any time. Typically, a new comment screen provides the user with a text box, in which the user can enter comments. If a user submits the new comments into the application, those new comments will be made available for viewing to other users. Comments may be viewed by accessing a list of all comments ever entered for a particular customer. That list may identify comments only by user name and comment date. A user might peruse the list and select one of the entries from the list to view. The application also provides a user with the capability of updating and deleting a comment that user previously entered for a customer. In one implementation, only a user that created a comment is permitted to modify or delete the comment.

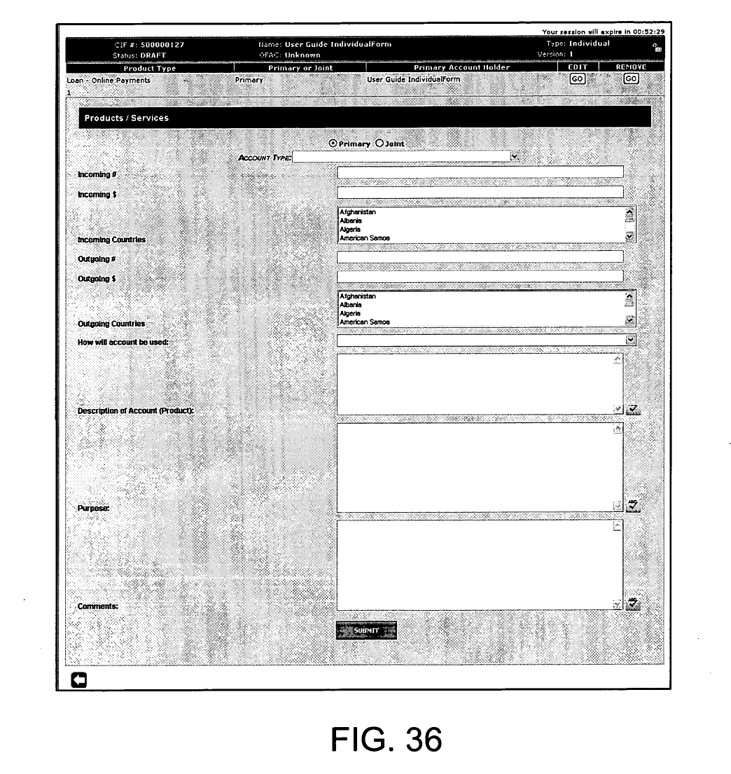

The screen of FIG. 36 is a report that identifies a list of products and/or services owned by a particular customer. The list is at an upper section of the page and includes only one entry. The list identifies product type, whether the customer is a primary or joint product holder and identification of the primary account holder. By selecting an entry in the list, a user can edit and/or view additional information about the selected product and/or service.

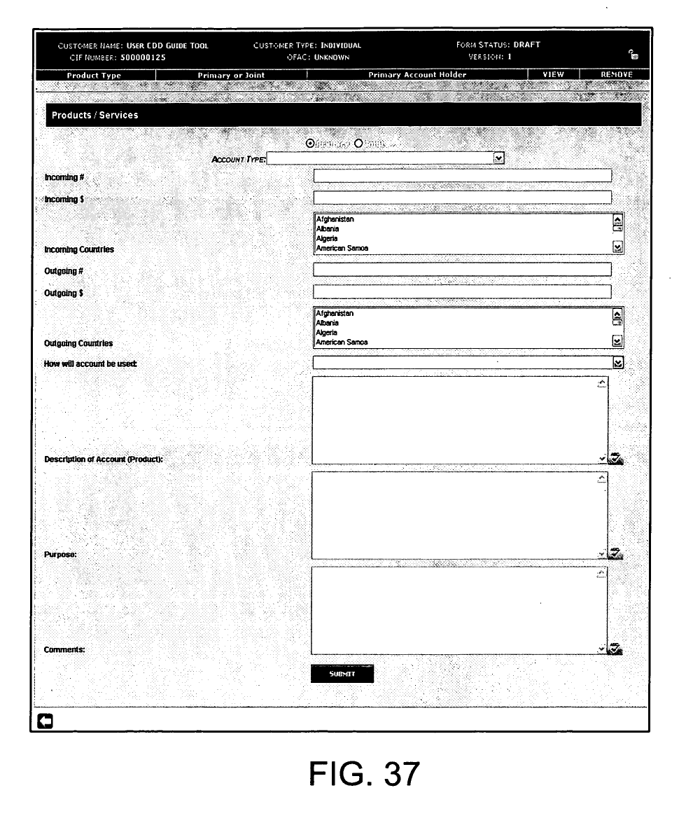

The screen also includes a “new” button, the selection of which prompts the system to present a screen that will enable the user to add a new product and/or service to the customer's form. An example of such a screen is shown in FIG. 37. That screen includes a number of fields in which the application requests information about the customer's new product and/or service.

A user accessing that screen would first identify the type of product/service that the customer is requesting and then enter the remaining information before submitting the new information to the application. Examples of account types include DDA accounts, N.O.W. accounts, money market accounts and loans. Each of those types of accounts may be further characterized as relating to wire transfers, U.S. cash, another country's cash, online payments, time deposits, check/debit card, loans, FX or trade finance.

If a user indicates that the customer is a joint account holder for the product or service being added to the customer's form, the application presents a screen listing available primary account holders. From that list, the user can select the primary account holder for the joint account being created. Alternatively, the application may simply provide an empty text box, within which the user can enter the name of the primary account holder.

At the top of the screen of FIG. 37 are three columns of information: the product type, whether the customer is a primary or joint account holder and the name (if applicable) of the primary account holder. The screen of FIG. 37 enables a user to describe particular transactional characteristics that a product/service is expected to have. For example, the system enables the user to identify how many incoming and outgoing transactions per month are expected, expected dollar amounts for those transactions, geographical areas involved, the expected purpose of the product/service, etc. The data collected in this screen can be passed to a monitoring system that monitors actual transactions that are conducted with respect to the product/service. If the actual transaction are sufficiently different that the expected transactions, then a user is notified of that discrepancy.

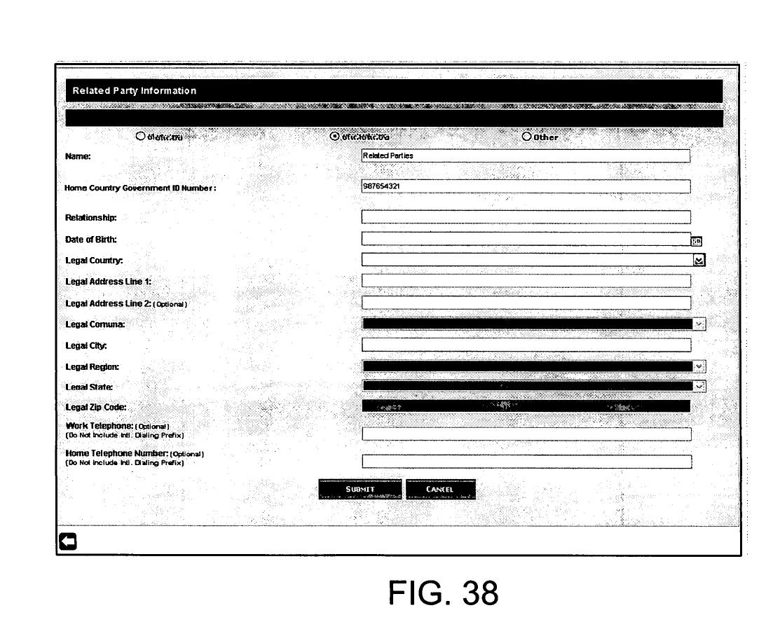

The application provides a user with functionality to add related parties to a customer's form. Such functionality may be provided through a dropdown menu that identifies various types of related parties, such as beneficiaries, officers/directors, relatives or other related parties. By selecting, for example, “other related party,” the user prompts the application to present a screen such as the one shown in FIG. 38. That screen includes dropdown menus and empty text fields requesting various data about the related party to be entered. Once a user enters data and selects the “submit” button, the application checks to see if the related party already exists in the system. If the related party does not already exist in the system, the application offers the user an opportunity to enter the related party in the system. If the related party has been identified in the system, the user will receive a message saying that the related party has been identified as an existing customer. The user will be presented with a list of customers that match the characteristics entered for the related customer and will be prompted to select one of the existing customers from the list.

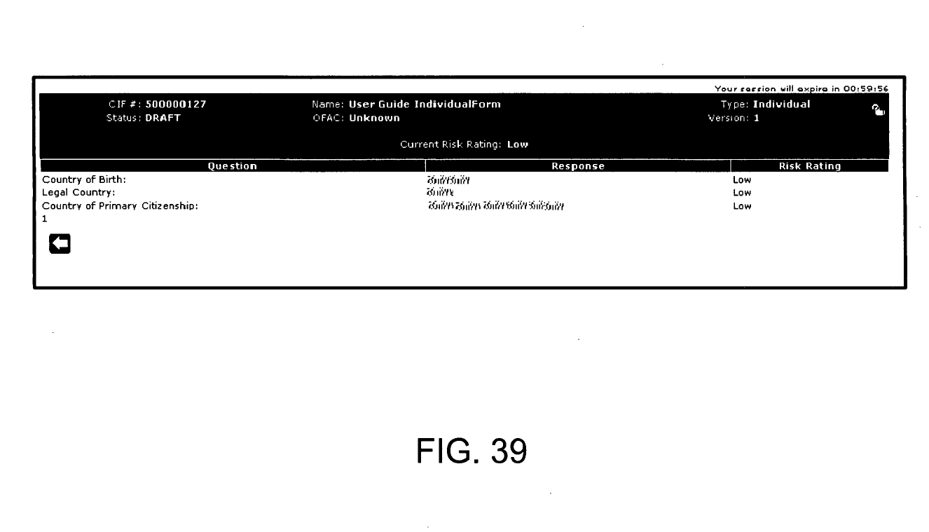

The screens shown in FIGS. 39-42 are summary reports that identify the risk rating assigned to particular customers and provide reasons why the risk rating was assigned.

The screen of FIG. 39, for example, is a summary report for a low risk rated customer. The report identifies the customer's current risk rating (i.e., low) and identifies the questions and answers that the application used to determine the outcome. The screen also identifies the risk rating associated with each question and answer combination indicated. In the illustrated implementation, the customer's risk score is low because all of the answers provided to questions about this customer were low risk answers.

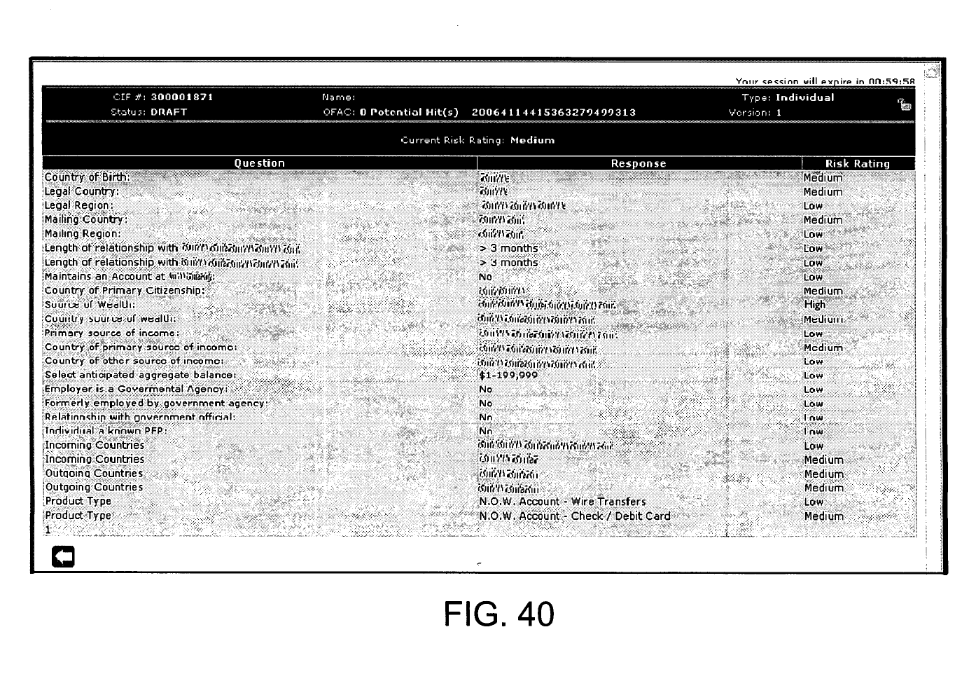

The screen of FIG. 40 is a summary report for a medium risk rated customer. The report identifies the customer's current risk rating (i.e., medium) and identifies the questions and answers that the application used to determine the outcome. The screen also identifies the risk rating associated with each question and answer combination indicated. In the illustrated implementation, the customer's risk score is medium because none of the answers provided to questions about this customer were considered more than medium risk answers.

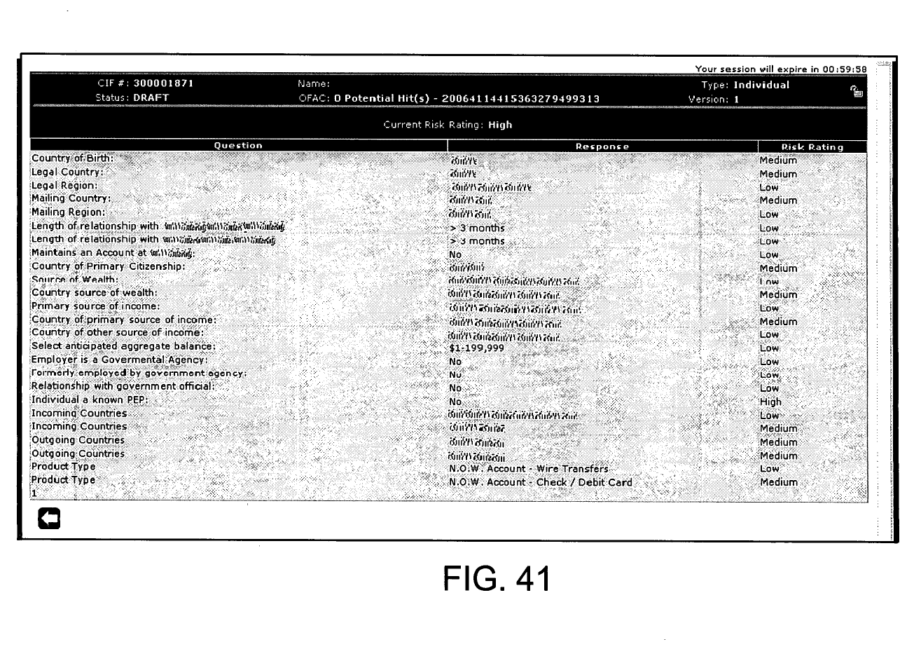

The screen of FIG. 41 is a summary report for a high risk rated customer. The report identifies the customer's current risk rating (i.e., high) and identifies the questions and answers that the application used to determine the outcome. The screen also identifies the risk rating associated with each question and answer combination indicated. In the illustrated implementation, the customer's risk score is high because at least one of the answers provided to questions about this customer was considered a high risk answer.

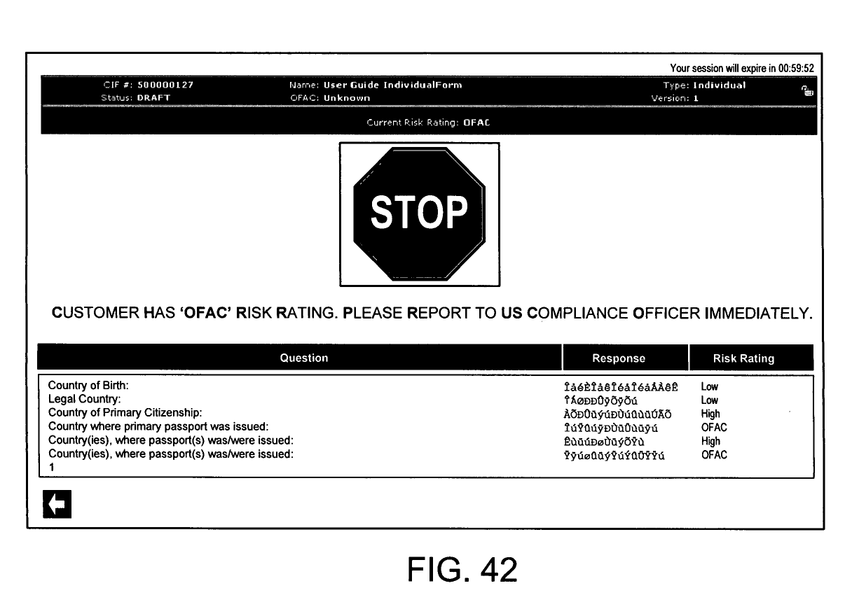

The screen of FIG. 42 is a summary report for an OFAC risk rated customer. The report identifies the customer's current risk rating (i.e., OFAC) and directs the user to report the determination to a U.S. compliance officer immediately. The report identifies the questions and answers that the application used to determine the outcome. The screen also identifies the risk rating associated with each question and answer combination indicated. In the illustrated implementation, the customer's risk score is OFAC because at least one of the answers provided to questions matched information from the OFAC watch list.

The application provides access to a customer revision history screen where certain users, depending on their role(s), can update information about particular customers. The customer revision history screen may include a list of revisions. The list may include a number of columns with information such as: customer identification number, customer name, status, version, date created and date last updated in each column.

The application also enables users to change customer information that appears in headers on various screens related to that customer. Such header information that might be changed includes: customer type, location, portfolio group, home country government identification number, customer's name and status. The user's ability to update that information may depend on the user's particular role.

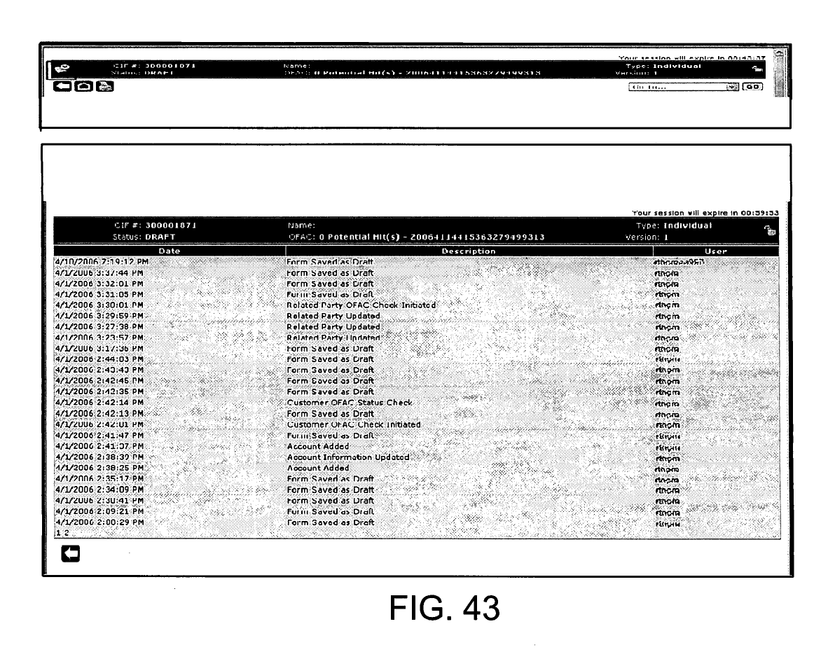

The application also enables a user to view an audit trail screen. An example of an audit trail screen is shown in FIG. 43. The illustrated audit trail provides a list of changes that have been made to a particular customer form including the date each change was made, a brief description of each change and the user who made each change. The list may be sorted by any one of those parameters. Any screen may include an audit trail icon that provides a link to the audit trail screen. In one implementation, such an icon may be provided on a customer survey form screen and on a compliance verification screen.

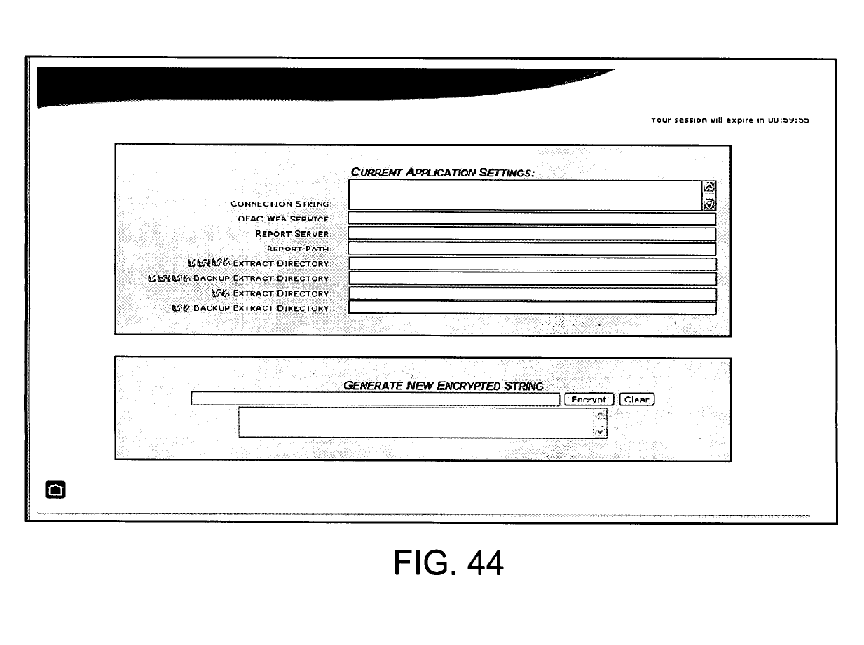

The application also provides access to an application configuration screen. An example of that screen is shown in FIG. 44. That screen enables a user to specify or change a database that the application accesses and to specify or change a directory which receives abstracts from the application. The user can also update encrypted configuration files with new encrypted values using the generate new encrypted string section. Encrypted values include application settings like the connection string and OFAC website address. Once the encrypted string is created in this section, the user can manually add it to the application configuration file.

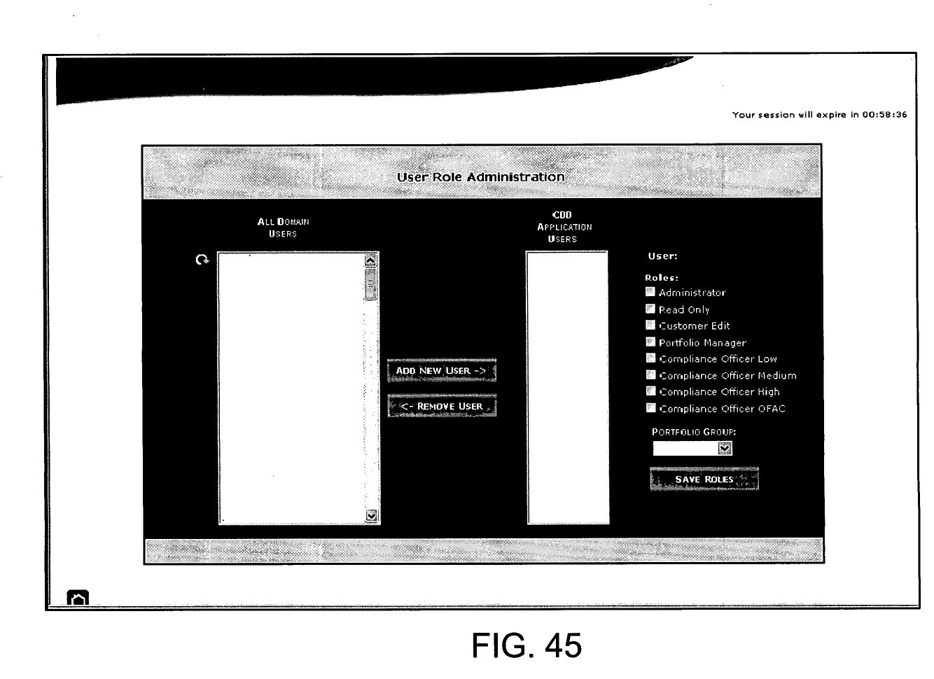

Selecting the “user administration” link from the main menu screen of FIG. 3 prompts the application to present a user role administration screen. An example of that screen is shown in FIG. 45. That screen allows the creation of new users, deletion of existing users, assigning or removing roles and portfolio groups. All user administration activity is recorded in a database table creating a history of changes for administrators to monitor and review.

As described herein, customer data is entered into the system by a user responding to numerous questions presented on various screens (a.k.a. “forms”), which represent part of the risk model.

The system provides users the ability to quickly and easily update those data collection forms. The CDD Application features web accessible form maintenance screens that give the user the ability to edit the customer information collection forms without making any changes to application itself. The user can thereby make changes to the risk model without needing to directly access and modify computer code that underlies the application.

In one implementation, there are two maintenance screens that allow the user to update to the content of the forms: 1) a question/available response maintenance screen and 2) a form maintenance screen. The following is a brief description of the primary functionality of these two screens.

The forms contained in the application contain a series of questions. The Question/Available Response (QAR) screen gives the user the ability to edit these questions and the associated available responses. When the QAR screen is opened, the user has the option of creating a new question, editing an existing question, or removing an existing question.

Questions sometimes have an associated available response or responses. The available responses to these questions can have can be many different types, among them free form text areas, dropdown boxes, radio buttons and checkboxes. Each different response type has unique, adjustable parameters, giving the user the ability to customize each question to have the look and feel required to most effectively convey the form content to the user. If the user chooses not to customize these attributes, the attributes will be assigned default values.

The response types also have ‘selection’ type responses, such as dropdown boxes and radio buttons that can be customized to reference different ‘dropdown groups’, each containing different available ‘dropdown items’. Additionally, the contents of these dropdown groups are also editable via the QAR screen. New dropdown groups can be added here as well. For instance, if a new question was created, and the contents of an existing dropdown group were not sufficient, the user could add an additional dropdown item to the existing group, or copy that group entirely and modify the newly copied group's dropdown items.

In some implementations, the system enables the user to specify an expected pattern or business rules that responses to particular questions should follow. That functionality can be particularly useful if the question under consideration requires an answer to be provided in a free flow text box. A free flow text box is a field that enables a user to enter any language therein. When a response to a question is entered, the system checks the entered response against the specified expected pattern and associated business rules. If the free form text entered is inconsistent with or violates the expected pattern, then the form will not submit and the user will be prompted to correct the entered response. The system also provides the reason for the rejection.

As an example, the question may ask for a social security number with a specified expected pattern of 3 digits, followed by 2 digits, followed by 4 digits. If the user types in a letter or 10 numbers, the system recognizes that the pattern is violated and prompts the user to correct the response. The system also indicates the reason why the entered response is being rejected.

Additionally, each question has a ‘risk weighting’ attribute. This attribute is defined at the question level and modifiable on the QAR screen. The Form Maintenance Screen allows the user to add, edit or remove questions to/from the CDD forms. When the Form Maintenance screen is opened, the user has the ability to open any of the forms that are displayed in CDD, and to modify the content of the form, by category (tab).

At the form level, the application can determine if certain questions should be active based on previously selected in responses of ‘selection’ type questions, such as dropdowns and radio buttons. This is called ‘enabling’. This is a form level attribute, and can be modified on the Form Maintenance screen.

An additional form level attribute of a question-response combination is the ‘risk multiplier’. In one implementation, the application uses a numeric scoring model (the overall risk model of the application is customizable). Based on the question's risk weighting and the different dropdown item's risk multiplier, each different question-response combination selected on the customer form may generate a different risk score. The risk multipliers for each dropdown item (by question, by form) can be updated on the Form Maintenance Screen.

Other aspects of the forms and the risk model to be used in evaluating customer risk can be modifiable through use of an appropriate maintenance screen.

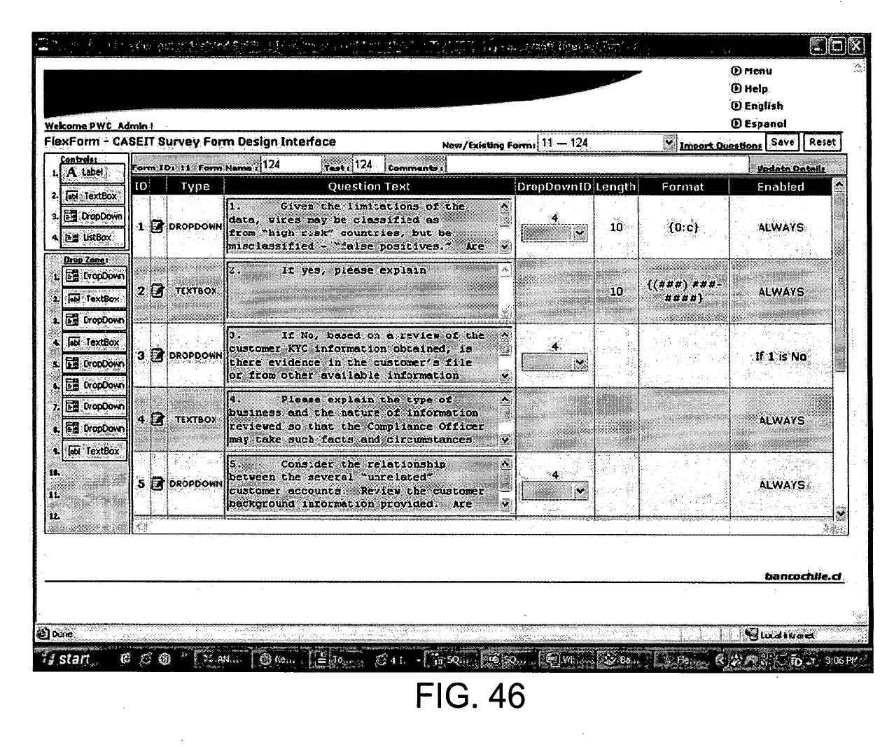

FIG. 46 is an example of a maintenance screen. The screen enables a user to modify a risk model used to assess customer risk. In one implementation, the risk model includes a set of questions that are adapted to solicit customer data relevant to evaluating the risk and rules for determining, based on responses to the questions, an overall risk rating associated with the customer. The screen enables the user to modify the risk through a browser-accessed screen, without requiring the user to directly access the underlying computer code. The functionality associated with the screen of FIG. 46 is an intuitive, user-friendly screen. Accordingly, a person lacking skill in computer programming would be able to modify the application very easily.

In particular, the illustrated screen enables a user to add, edit and delete questions on various screens that the application presents to a user. Additionally, that screen may be modified to enable a user to specify risk ratings that should be assigned to various responses that a user might submit to the questions indicated.

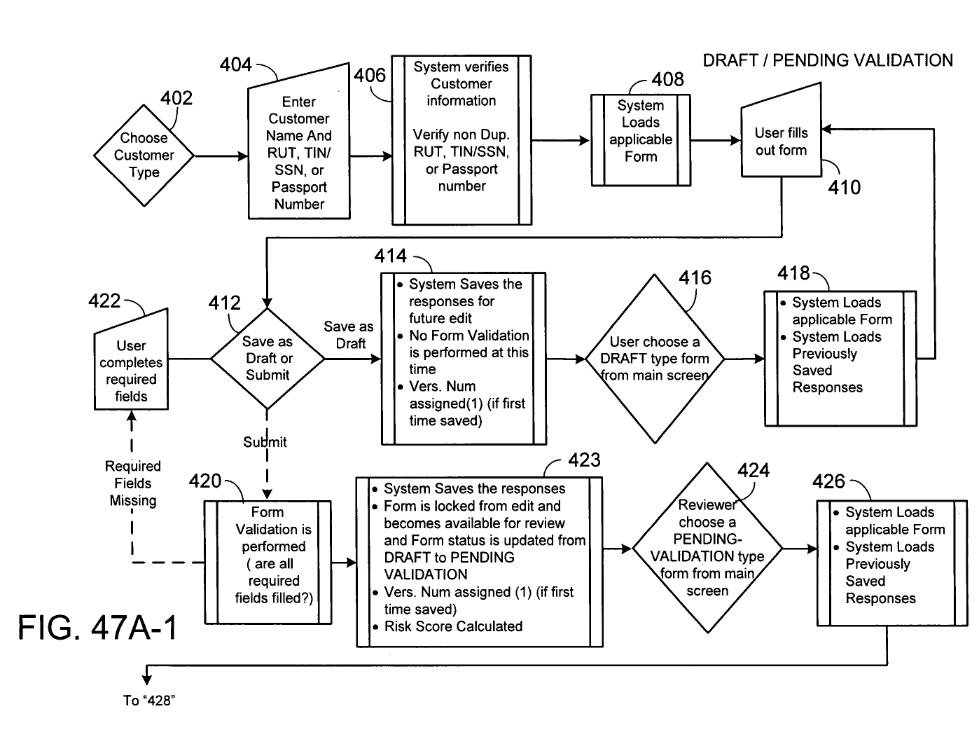

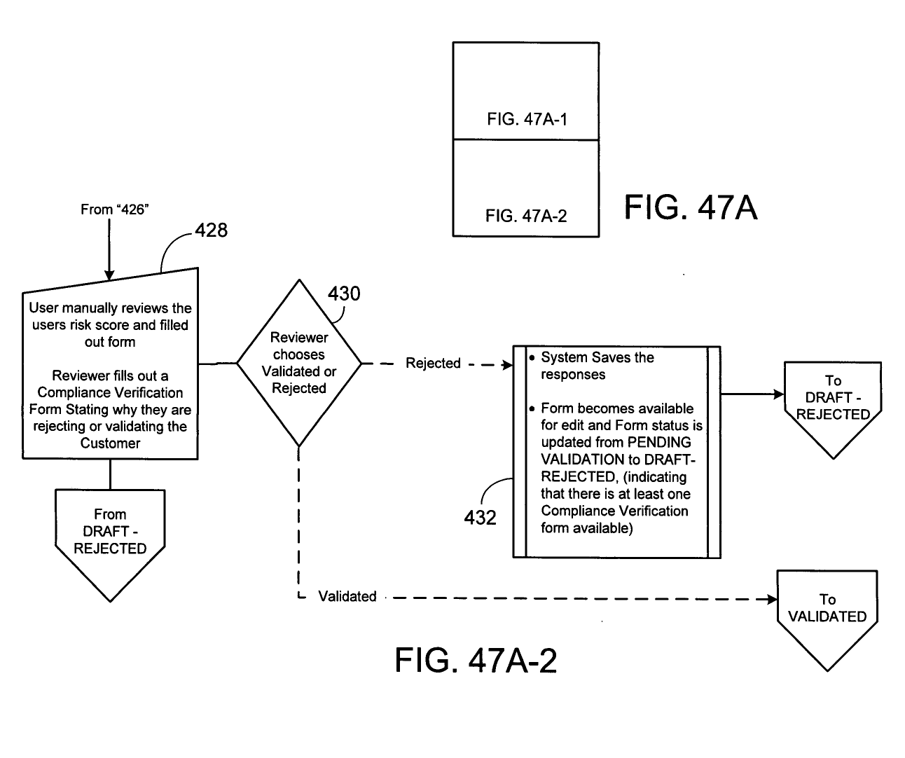

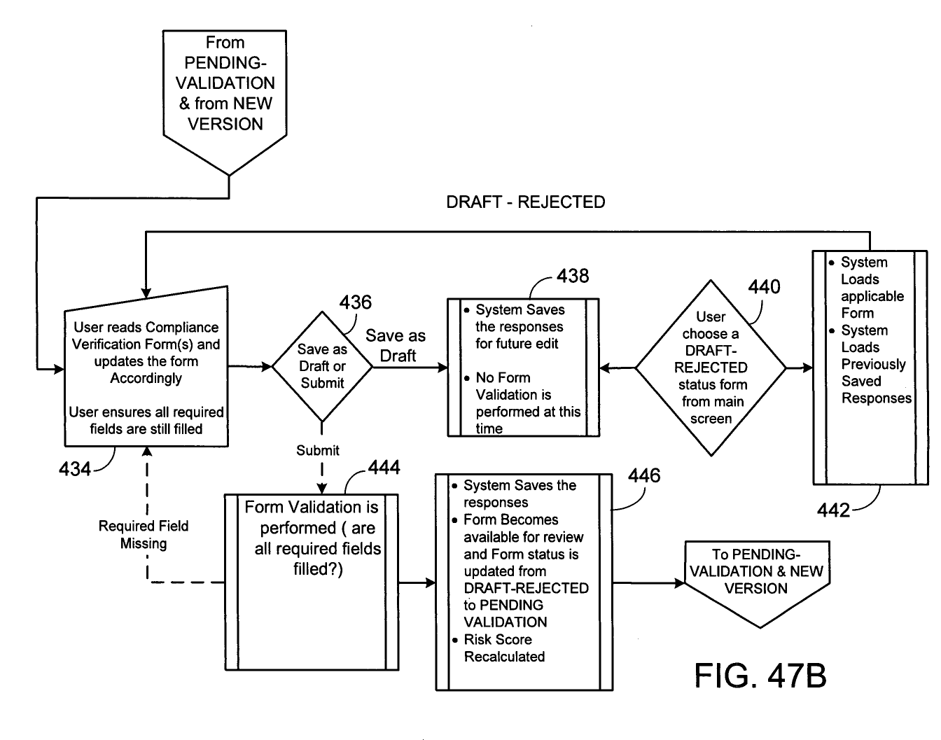

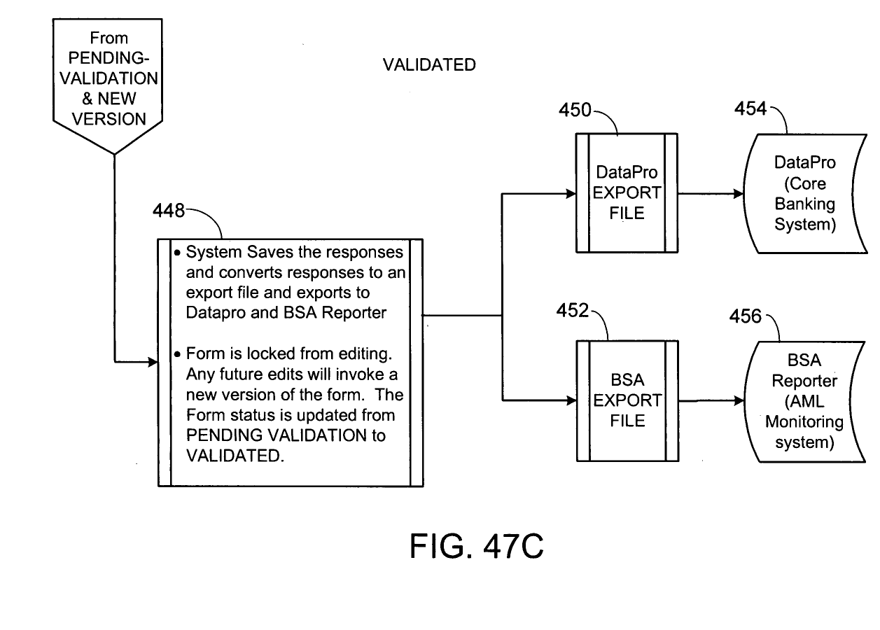

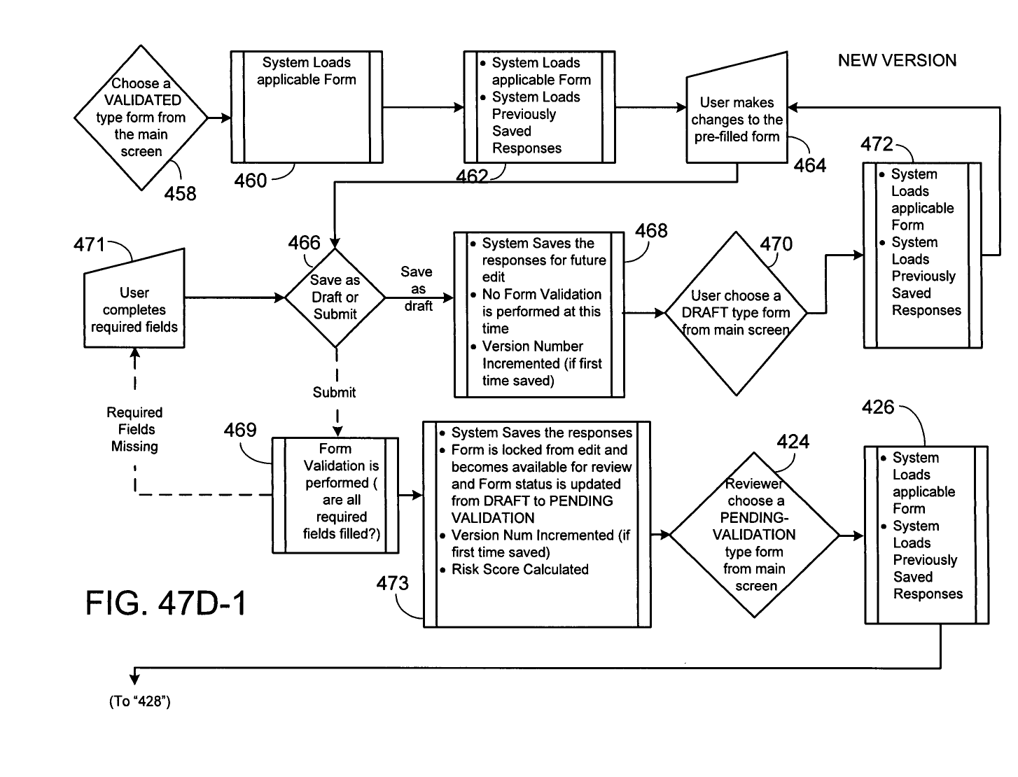

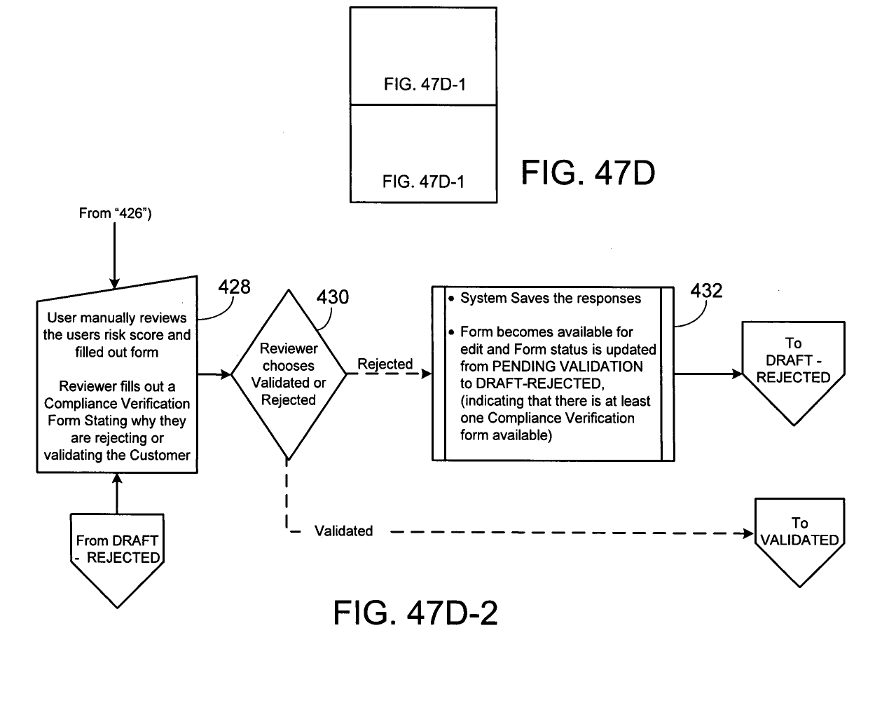

FIGS. 47a-47d disclose a flowchart of a customer validation process implemented when a bank obtains a potential new customer or creates a new version of an existing customer's information form. At least some of the blocks disclosed in the flowchart can be performed by a computer system that includes a graphical interface, a processing unit and a memory storage device.

Referring to FIG. 47a, a user first chooses 402 a customer type. The user then enters 404 the customer's name and other identification information (e.g., U.S. or foreign country tax identification number, social security number, passport number, etc.). The system then verifies 406 that the entered customer information is non-DUP, i.e., not a duplicate entry. The system then loads 408 the applicable form that the user will be required to fill out. The status of the form is “draft.” The user then fills out 410 the form presented. If, for example, the user does not finish filling out the forms, the user might decide (at 412) to save the partially filled out form as a draft. If the user decides to do that, the system saves 414 the draft form (including the partially entered responses) for future editing. No form validation is performed. However, a version number is assigned to the saved draft. Version 1 is assigned if it is the first time the form is being saved.

At some later time, the user might access the system again with intentions to continue editing the saved draft form. In that circumstance, the user prompts the system to load the applicable form, which is used to collect relevant customer data. The user does this by choosing 416 an appropriate draft form from a main screen presented at the graphical interface. In response, the system loads 418 the applicable form with the previously saved responses. The user then can continue filling out the form 410.

If, for example, the user finishes filling out the customer form(s), the user might decide (at 412) to submit the filled out form for validation. In response, the system performs 420 a form validation which checks that all required fields have been filled out. If the system determines that any required fields have not been filled out, the user may be prompted to complete the required fields. Once the user completes 422 the required fields, the user might resubmit 412 the form for validation.

Once the system is satisfied that all required fields have been filled out, the system saves 423 the form including all responses. The form is locked from further editing and becomes available for review. The form's status is upgraded from “draft” to “pending validation.” A version number is assigned to the form. Version number 1 is assigned if it is the first time the form is being saved. Also, a risk score (risk rating) is calculated based on the completed form.

When the user decides to review the form for possible validation, the user chooses 424 the form, whose status is “pending validation” from a main screen presented at the graphical interface. In response, the system loads 426 the applicable form, including the previously saved responses. The user then manually reviews 428 the customer's risk score (risk rating) and the filled out form. The user also fills out a compliance verification form(s) providing reasons why the customer is being validated or rejected. The user chooses (at 430) whether the customer is being rejected or validated.

If the customer is being rejected, the system saves 432 the responses, the form becomes available for editing and the form status is changed from “pending validation” to “draft-rejected.” The system may also indicate that there is at least one compliance verification form available.

If the user wants to attempt to change the status of a “draft-rejected” customer, the user may read 434 (see FIG. 47b) the compliance verification form(s) and update the customer form accordingly. If, for example, the user has not completed updating the customer form, the user may decide (at 436) to save the partially updated customer form as a draft. In response, the system saves 438 the responses for future editing. No form validation is performed at that time.

When the user decides to continue updating the customer form, the user chooses 440 the appropriate form, whose status is draft-rejected, from a main screen presented by the graphical interface. In response, the system loads 442 the applicable form and previously saved responses. The user can continue updating the customer form at box 434.

If the user completes updating the customer form according to address any issues raised in the compliance verification form(s), the user might decide (at 436) to submit the updated customer form. In response, the system performs 444 a form validation ensuring that all required fields are filled in. If all required fields are not filled in, the user might be prompted to further update the customer form. Otherwise, the system saves 446 the responses, the updated form becomes available for review and the form status is changed from “draft-rejected” to pending validation.” Also, the customer's risk score (risk rating) is recalculated. The process continues at box 428 in FIG. 47a.

Instead of deciding (at 430) to reject the customer form, the user might decide (at 430) to validate the customer form. In response, the system saves 448 (see FIG. 47c) the responses and converts the responses to export files 450, 452 for exporting to a core banking system 454 (e.g., Data Pro™) and/or an anti-money laundering system 456 (e.g., BSA Reporter™). BSA Reporter™ detects, analyzes and reports suspicious transaction activity that may be present, utilizing a rules engine and customer profiling techniques.

FIG. 47d details how a user might make changes to an existing, previously-validated customer form. To begin, a user chooses 458 a form associated with a customer, whose status is “validated.” The choice is made from a main screen presented at a graphical interface. In response, the system loads 460 the applicable form and loads 462 previously-saved responses. The user then makes 464 changes to the pre-filled form. The user then decides (at 466) whether to save the updated form as a draft or to submit the updated form for validation. If the user decides to save the updated form as a draft, the system saves 468 the updated form for future editing, no form validation is performed and, if this is the first time the updated form is being saved, the version number is incremented.

When the user decides to continue the process, the used chooses 470 the appropriate form, whose status is identified as “draft” from a main screen presented at the graphical interface. In response, the system then loads 472 the applicable form including the previously saved responses. The user then continues to make 464 changes as required.

When the user finished entering new information to the customer form, the user might decide (at 466) to submit the updated customer form for validation. In response, the system performs 469 a form validation ensuring that all required fields are filled. If any required fields are missing, the user might be prompted, and the user completes 471 the required fields. If all required fields have been filled out, the system saves 473 the responses, the form is locked from further editing, the form becomes available for review, the status is changed from “draft” to “pending validation” and, if this is the first time the updated form is being saved, the version number is incremented. Also, the risk score (risk rating) is calculated.

Blocks 424, 426, 428, 430 and 432 are identical to the identically numbered blocks discussed above with reference to FIG. 47a. Interfaces with FIGS. 47b and 47d also are identical.

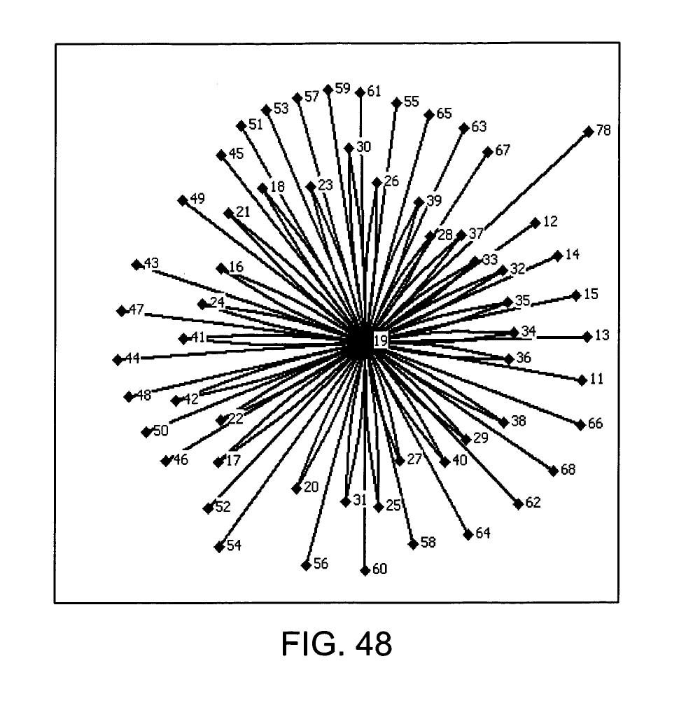

The system also may be adapted to create social network diagrams based on various customer data. An example of social network diagram that the system can create is shown in FIG. 48. In that figure, customers are represented by shapes (e.g., diamonds or ovals). Next to each shape is a number, which is an identification number for the associated customer. Relationships between customers are indicated by lines connecting the shapes. The lines may be color-coded or otherwise adapted to provide an indication of the type of relationship that exists between the customers at either end of the line. For example, different line colors can be used to indicate whether the related customers share geographical data, phone numbers, transactions, identification numbers, or account numbers. The level of risk associated with each customer can be visually represented by colors or levels of shading inside the shape that corresponds to that customer. As an example, shapes with darker colors can be used to indicate higher risk customers and shapes with lighter colors can be used to indicate lower risk customers.

In the illustrated implementation, shading provided in the shape corresponding to customer 19 indicates that customer 19 is considered a high risk customer. Customer 19 is related to several other customers. Shapes that correspond to those other customers are arranged around the shape corresponding to customer 19 and are connected to customer 19 by lines, each of which can be colored (or otherwise customized) to represent a particular type of relationship.

Most of the customers that are shown as being related to customer 19 are considered low risk customers. However, the shape corresponding to customer 48 is shaded to indicate that customer 48 is a high risk customer. That two high risk customers have a relationship with each other may be of interest to a user. The visual representation provided makes it easy to recognize that such relationships, which may have otherwise gone unrecognized, exist.

The illustrated visual social network diagram also shows an indirect relationship that exists between the customer that corresponds to shape 19 and another high risk customer that corresponds to shape 100. It can be seen that a relationship exists between the customer 19 and customer 62 and a relationship exists between customer 62 and customer 100. A user might be interested in knowing that such an indirect relationship exists between two high risk customers. The illustrated visual social network diagram that the system creates (and presents on a user interface) facilitates identifying the existence of such relationships.

The system provides functionality that allows a user to customize the information to be included in a visual social network. For example, in one implementation, the user is able to select one or more individuals, non-individuals, financial institutions, beneficiaries and/or other parties, with which the system will create a social network diagram. The user also can specify how many degrees of separation the system should consider in trying to link the selected parties.

An example of a direct relationship is where customer A is related to customer B. An example of an indirect relationship (transitive) is where customers A and B share an account and customer B also shares an account with C. Although A and C do not share an account they are indirectly related through B.

The system also can prepare risk heat maps that show how risk is distributed, for example, geographically in a given area. That functionality might help a user to identify, for example, areas where a high concentration of high risk users are located. That information might help the user to more accurately assess risk associated with customers located in that area.

In one implementation, the user is provided the ability to select geography, product, legal type, entity type, customer type, branch, account officer, or other various pivot points and visually see the areas of customer higher risk by color (i.e., geography would display a map and the map would have shades of colors with blue being low risk and red high risk based on groupings of where the customers are domiciled).

A number of implementations have been described. Nevertheless, various modifications may be made without departing from the spirit and scope of the invention. For example, other methods of calculating a risk rating for the customers may be used. Additionally, other resources can be referenced to determine whether a particular customer should be considered a risk. Other factors may be considered relevant to determining whether a particular customer poses a risk. Also, the data may be presented to and solicited from a user in a variety of different ways.

Additionally, the method can include calculating an overall risk rating for an entire customer base. Such an overall risk rating might be calculated using a weighted average approach. Other calculating methods can be implemented as well.

Additionally, the system can be adapted to identify a change in risk distribution across a pre-defined portion of the customer population in response to a user's modification of the risk model. For example, a user might change the risk model so that a customers from a particular country, who were previously considered medium risk, will subsequently be considered high risk. In response to that change, the system can identify the resulting change in risk distribution across a pre-defined portion of the customer population. So, if 10% of the user's entire customer population were previously considered high risk, and that risk model change resulted in 80% of the user's customer base being considered high risk, the system will notify the user of that information.

The methods can include the ability to search every field of customer data in a variety of different ways. For example, the database of customer information that is created may be searchable based on keywords. The search capability may be adaptable in a variety of ways, for example, to enable the user to exclude certain terms from searches. Toward that end, the system can include a robust search engine.

The methods can include enabling a user to customize question branching logic that the system implements to solicit required information about each customer. Such question branching logic includes specifying if and how subsequent questions that are presented to a user should depend on answers to previous questions. So, for example, if a user responds to a question that the customer is a financial institution, the system may implement question branching logic to ask for a tax identification number (but not a social security number). Alternatively, if the user responds that the customer is an individual, the system can know (based on the customized question branching logic) to ask for a social security number (and not a tax identification number).

The methods can include presenting the user with a customer information/identification program checklist that presents the user with a list of required customer documents and/or information based on the type of customer (e.g., individual, non-individual, financial institution) being considered. Examples of the types of list entries that can be provided in such a list include articles of incorporation, bank charter and driver's license. The system also can enable a user to upload electronic copies of particular documents, create links to those electronic copies in a document management system, and specify either that a hardcopy of the document has been received or will be received shortly. If a hard copy has not yet been received, the system can remind the user to obtain the hard copy at some later time.

Although the methods and systems disclosed herein are directed specifically to evaluating risk of money laundering and terrorist financing, the methods can be adapted to evaluate risk of other customer activities (or types of activities) as well. For example, the methods may be adapted to evaluate credit risk, general compliance and customer documentation requirements.

The system disclosed herein may be adapted to interface and communicate with a variety of external systems and take particular actions in response to interactions with those external systems.

Various features of the system can be implemented in hardware, software, or a combination of hardware and software. For example, some features of the system can be implemented in computer programs executing on programmable computers. Each program can be implemented in a high level procedural or object-oriented programming language to communicate with a computer system. Furthermore, each such computer program can be stored on a storage medium, such as memory readable by a general or special purpose programmable computer or processor, for configuring and operating the computer when the storage medium is read by the computer to perform the function described above.

Other implementations are within the scope of the following claims.

What is claimed is:

1. A computer-implemented method of evaluating risk associated with a financial organization's customer, the method comprising:
prompting a user to respond to a set of questions adapted to solicit customer data relevant to evaluating the risk, wherein the questions are part of a first risk model that comprises rules for determining an overall risk rating associated with the customer based on user responses to the questions;
quantifying risks associated with individual responses from the user based on the first risk model; and
determining a first overall risk rating for the customer based on the quantified risks.

2. The computer-implemented method of claim 1 further comprising enabling a user to modify the first risk model to create a second risk model.

3. The computer-implemented method of claim 2 further comprising:
revising the quantified risks associated with the individual responses from the user based on the second risk model; and
determining a second overall risk rating for the customer based on the revised quantified risks.

4. The computer-implemented method of claim 3 further comprising:
identifying a change from the first overall risk rating to the second overall risk rating; and
identifying a cause of the change.

5. The computer-implemented method of claim 2 further comprising:
identifying a change in risk distribution across a pre-defined portion of the customer population in response to the user modification.

6. The computer-implemented method of claim 2 further comprising:
in response to the user modifying the risk model, prompting the user to respond to a modified set of questions; and
determining, based on the modified risk model, a second overall risk rating for the customer.

7. The computer-implemented method of claim 6 further comprising identifying a change from the first overall risk rating to the second overall risk rating and identify a cause of the change.

8. The computer-implemented method of claim 2 wherein enabling the user to modify the first risk model comprises:
enabling the user, through a graphical interface, to edit the set of questions adapted to solicit customer data relevant to evaluating the risk.

9. The computer-implemented method of claim 2 wherein enabling the user to modify the first risk model comprises:
enabling the user, through a graphical interface, to specify a selection of available answers to one or more of the questions in the set.

10. The computer-implemented method of claim 2 wherein enabling the user to modify the first risk model comprises:
enabling the user, through a graphical interface, to edit logic used to quantify the risks associated with the individual responses from the user.

11. The computer-implemented method of claim 2 wherein enabling the user to modify the first risk model comprises:
enabling the user, through a graphical interface, to edit logic used to determine the first overall risk rating for the customer based on the quantified risks.

12. The computer-implemented method of claim 2 wherein enabling the user to modify the first risk model comprises:
enabling the user, through a graphical interface, to edit question branching logic.

13. The computer-implemented method of claim 1 further comprising:
storing as a first version, the user's responses to the set of questions adapted to solicit customer data relevant to evaluating the risk;
enabling the user to subsequently amend one or more of the user's responses;
storing as a second version, a second set of user responses including the user's amended responses; and
presenting the first version and the second version to the user for comparison.

14. The computer-implemented method of claim 1 further comprising:
enabling a user to select a customer; and
creating a diagram that provides a visual representation of the selected customer's relationships with other customers and risks associated with the selected customer and the other customers.

15. The computer-implemented method of claim 14 wherein the diagram is a social network diagram, the method further comprising:
visually representing the selected customer and the related customers, wherein the visual representations are indicative of a respective risk associated with the corresponding customer, and
connecting the visual representations for the selected customer to each of the visual representations for related customers with one or more lines that are respectively indicative of types of relationship that exist between the selected customer and the related customers.

16. The computer-implemented method of claim 14 wherein the diagram is a risk heat map, the method further comprising:
creating a map having a plurality of sections; and
customizing each section of the map according to a risk associated with that section, wherein the risk associated with each particular section is based on the concentration of and risks associated with the customers in each section.

17. The computer-implemented method of claim 1 wherein quantifying the risk associated with each user response comprises assigning a risk rating of high, medium or low to each user response.

18. The computer-implemented method of claim 17 wherein determining the first overall risk rating comprises:
assigning a high overall risk rating to the customer if at least one of the quantified risk ratings is high;
assigning a low overall risk rating to the customer if all of the quantified risk ratings are low; and
otherwise assigning a medium overall risk rating to the customer.

19. The computer-implemented method of claim 1 wherein quantifying the risk associated with individual user responses comprises assigning a numerical risk rating to the individual user responses.

20. The computer-implemented method of claim 19 wherein determining the first overall risk rating comprises:
assigning respective weights to the individual user responses; and
calculating a numerical weighted risk rating as the overall risk rating for the customer.

21. The computer-implemented method of claim 2 further comprising:
storing the first and second risk models; and
providing a comparison of the first risk model and the second risk model.

22. The computer-implemented method of claim 21 further comprising:
providing an indication of differences between the first and second risk models.

23. The computer-implemented method of claim 1 wherein the risk evaluated is a risk that the customer will engage in either money laundering activities or terrorist financing activities.

24. A computer system comprising:
a graphical interface;
a processing unit coupled to the graphical interface; and
a memory storage unit coupled to the processing unit,
wherein the processing unit is adapted to:
prompt a user, through the graphical interface, to respond to a set of questions adapted to solicit customer data relevant to evaluating the risk, wherein the questions are part of a first risk model stored in the memory storage unit that comprises rules for determining an overall risk rating associated with the customer based on user responses to the questions;
quantify risks associated with individual responses from the user based on the first risk model; and
determine a first overall risk rating for the customer based on the quantified risks.

25. The computer system of claim 24 wherein the processing unit is further adapted to enable a user to modify the first risk model to create a second risk model.

26. The computer system of claim 25 wherein the processing unit is further adapted to:
revise the quantified risks associated with the individual responses from the user based on the second risk model; and
determine a second overall risk rating for the customer based on the revised quantified risks.

27. The computer system of claim 26 wherein the processing unit is further adapted to:
identify a change from the first overall risk rating to the second overall risk rating; and
identify a cause of the change.

28. The computer system of claim 25 wherein the processing unit is further adapted to:
identify a change in risk distribution across a pre-defined portion of the customer population in response to the user modification.

29. The computer system of claim 25 wherein the processing unit is further adapted to:
in response to the user modifying the risk model, prompt the user to respond to a modified set of questions; and
determine, based on the modified risk model, a second overall risk rating for the customer.

30. The computer system of claim 29 wherein the processing unit is further adapted to identify a change from the first overall risk rating to the second overall risk rating and identify a cause of the change.

31. The computer system of claim 25 wherein the processing unit is further adapted to:
enable the user, through the graphical interface, to edit the set of questions adapted to solicit customer data relevant to evaluating the risk.

32. The computer system of claim 25 wherein the processing unit is further adapted to:
enable the user, through the graphical interface, to specify a selection of available answers to one or more of the questions in the set.

33. The computer system of claim 25 wherein the processing unit is further adapted to:
enable the user, through the graphical interface, to edit logic used to quantify the risks associated with the individual responses from the user.

34. The computer system of claim 25 wherein the processing unit is further adapted to:
enable the user, through the graphical interface, to edit logic used to determine the first overall risk rating for the customer based on the quantified risks.

35. The computer system of claim 25 wherein the processing unit is further adapted to:
enable the user, through the graphical interface, to edit question branching logic.

36. The computer system of claim 24 wherein the processing unit is further adapted to:
store, as a first version in the memory storage unit, the user's responses to the set of questions adapted to solicit customer data relevant to evaluating the risk;
enable the user to subsequently amend one or more of the user's responses;
store, as a second version in the memory storage unit, a second set of user responses including the user's amended responses; and
present the first version and the second version on the graphical interface to the user for comparison.

37. The computer system of claim 24 wherein the processing unit is further adapted to:
enable a user to select a customer; and
create a diagram that provides a visual representation of the selected customer's relationships with other customers and risks associated with the selected customer and the other customers.

38. The computer system of claim 37 wherein the diagram is a social network diagram, wherein the processing unit is further adapted to:
visually represent, on the graphical interface, the selected customer and the related customers, wherein the visual representations are indicative of a respective risk associated with the corresponding customer, and
connect the visual representations for the selected customer to each of the visual representations for related customers with one or more lines that are respectively indicative of types of relationship that exist between the selected customer and the related customers.

39. The computer system of claim 37 wherein the diagram is a risk heat map, wherein the processing unit is further adapted to:
create a map, for display on the graphical interface, the map having a plurality of sections; and
customize each section of the map according to a risk associated with that section, wherein the risk associated with each particular section is based on the concentration of and risks associated with the customers in each section.

40. The computer system of claim 24 wherein the processing unit is further adapted to quantify the risk associated with each user response by assigning a risk rating of high, medium or low to each user response.

41. The computer system of claim 24 wherein the processing unit is further adapted to determine the first overall risk rating by:
assigning a high overall risk rating to the customer if at least one of the quantified risk ratings is high;
assigning a low overall risk rating to the customer if all of the quantified risk ratings are low; and
otherwise assigning a medium overall risk rating to the customer.

42. The computer system of claim 24 wherein the processing unit is further adapted to quantify the risk associated with individual user responses by assigning a numerical risk rating to the individual user responses.

43. The computer system of claim 42 wherein the processing unit is further adapted to determine the first overall risk rating by:
assigning respective weights to the individual user responses; and
calculating a numerical weighted risk rating as the overall risk rating for the customer.

44. The computer system of claim 24 wherein the processing unit is further adapted to:
store the first and second risk models in the memory storage unit; and
provide a comparison of the first risk model and the second risk model.

45. The computer system of claim 44 wherein the processing unit is further adapted to:
provide, on the graphical interface, an indication of differences between the first and second risk models.

46. The computer system of claim 24 wherein the processing unit is further adapted to evaluate a risk that the customer will engage in either money laundering activities or terrorist financing activities.

47. The computer system of claim 24 wherein the processing unit is further adapted to:
import previously-entered user responses to the set of questions;
identify if any of the previously-entered user responses are incomplete or violate pre-defined business rules; and
prompt the user, through the graphical interface, to update the previously-entered user responses that are incomplete or that violate the pre-defined business rules.

48. An article comprising a computer-readable medium that stores computer-executable instructions for causing a computer system to:
prompt a user to respond to a set of questions adapted to solicit customer data relevant to evaluating the risk, wherein the questions are part of a first risk model that comprises rules for determining an overall risk rating associated with the customer based on user responses to the questions;
quantify risks associated with individual responses from the user based on the first risk model; and
determine a first overall risk rating for the customer based on the quantified risks.

49. The article of claim 48 further storing computer-executable instructions for causing the computer system to:
enable the user to modify the first risk model to create a second risk model.

50. The article of claim 49 further storing computer-executable instructions for causing the computer system to:
revise the quantified risks associated with the individual responses from the user based on the second risk model; and
determine a second overall risk rating for the customer based on the revised quantified risks.

51. The article of claim 50 further storing computer-executable instructions for causing the computer system to:
identify a change from the first overall risk rating to the second overall risk rating; and
identify a cause of the change.

52. The article of claim 49 further storing computer-executable instructions for causing the computer system to:
identify a change in risk distribution across a pre-defined portion of the customer population in response to the user modification.

53. The article of claim 49 further storing computer-executable instructions for causing the computer system to:
in response to the user modifying the risk model, prompt the user to respond to a modified set of questions; and
determine, based on the modified risk model, a second overall risk rating for the customer.

54. The article of claim 53 further storing computer-executable instructions for causing the computer system to:
identify a change from the first overall risk rating to the second overall risk rating; and
identify a cause of the change.

55. The article of claim 49 further storing computer-executable instructions for causing the computer system to:
enable the user, through a graphical interface, to edit the set of questions adapted to solicit customer data relevant to evaluating the risk.

56. The article of claim 49 further storing computer-executable instructions for causing the computer system to:
enable the user, through a graphical interface, to specify a selection of available answers to one or more of the questions in the set.

57. The article of claim 49 further storing computer-executable instructions for causing the computer system to:
enable the user, through a graphical interface, to edit logic used to quantify the risks associated with the individual responses from the user.

58. The article of claim 49 further storing computer-executable instructions for causing the computer system to:
enable the user, through a graphical interface, to edit logic used to determine the first overall risk rating for the customer based on the quantified risks.

59. The article of claim 49 further storing computer-executable instructions for causing the computer system to:
enable the user, through a graphical interface, to edit question branching logic.

60. The article of claim 48 further storing computer-executable instructions for causing the computer system to:
store, as a first version, the user's responses to the set of questions adapted to solicit customer data relevant to evaluating the risk;
enable the user to subsequently amend one or more of the user's responses;
store, as a second version, a second set of user responses including the user's amended responses; and
present the first version and the second version to the user for comparison.

61. The article of claim 48 further storing computer-executable instructions for causing the computer system to:
enable a user to select a customer; and
create a diagram that provides a visual representation of the selected customer's relationships with other customers and risks associated with the selected customer and the other customers.

62. The article of claim 61 wherein the diagram is a social network diagram, wherein the article further stores computer-executable instructions for causing the computer system to:
visually represent the selected customer and the related customers, wherein the visual representations are indicative of a respective risk associated with the corresponding customer, and
connect the visual representations for the selected customer to each of the visual representations for related customers with one or more lines that are respectively indicative of types of relationship that exist between the selected customer and the related customers.

63. The article of claim 61 wherein the diagram is a risk heat map, wherein the article further stores computer-executable instructions for causing the computer to:
create a map having a plurality of sections; and
customize each section of the map according to a risk associated with that section, wherein the risk associated with each particular section is based on the concentration of and risks associated with the customers in each section.

64. The article of claim 48 wherein the article further stores computer-executable instructions for causing the computer to:
assign a risk rating of high, medium or low to each user response.

65. The article of claim 64 wherein the article further stores computer-executable instructions for causing the computer to:
assign a high overall risk rating to the customer if at least one of the quantified risk ratings is high;
assign a low overall risk rating to the customer if all of the quantified risk ratings are low; and
otherwise assign a medium overall risk rating to the customer.

66. The article of claim 48 wherein the article further stores computer-executable instructions for causing the computer to assign a numerical risk rating to the individual user responses.

67. The article of claim 66 wherein the article further stores computer-executable instructions for causing the computer to:
assign respective weights to the individual user responses; and
calculate a numerical weighted risk rating as the overall risk rating for the customer.

68. The article of claim 49 wherein the article further stores computer-executable instructions for causing the computer to:
store the first and second risk models; and
provide a comparison of the first risk model and the second risk model.

69. The article of claim 68 wherein the article further stores computer-executable instructions for causing the computer to:
provide an indication of differences between the first and second risk models.

70. The article of claim 48 wherein the article further stores computer-executable instructions for causing the computer to evaluate a risk that the customer will engage in either money laundering activities or terrorist financing activities.
